(19) United States
(12) Patent Application Publication
(10) Pub. No.: US 2014/0344306 A1
(43) Pub. Date: Nov. 20, 2014

(54) INFORMATION SERVICE THAT GATHERS INFORMATION FROM MULTIPLE INFORMATION SOURCES, PROCESSES THE INFORMATION, AND DISTRIBUTES THE INFORMATION TO MULTIPLE USERS AND USER COMMUNITIES THROUGH AN INFORMATION-SERVICE INTERFACE

(71) Applicant: VULCAN , Inc., Seattle, WA (US)

(72) Inventors: Jeffrey Lewis Bowden, Seattle, WA (US); Annabel Christine Sherwood, Seattle, WA (US); Paul Gardner Allen, Seattle, WA (US); Matthew Greene, Tukwila, WA (US); Brian G. Milnes, Seattle, WA (US); Jeffrey Quinn Robinson, North Bend, WA (US); Stuart Fischer Graham, Seattle, WA (US); April Irene O'Rourke, Seattle, WA (US); Owyn More Richen, Renton, WA (US); Jeremy Leon Calvert, Seattle, WA (US); Jeffrey R. Meyers, Tacoma, WA (US); Daniel Reed Sterling, Mill Creek, WA (US)

(73) Assignee: VULCAN , Inc., Seattle, WA (US)

(21) Appl. No.: 14/094,680

(22) Filed: Dec. 2, 2013

Related U.S. Application Data
(63) Continuation of application No. 11/234,405, filed on Sep. 23, 2005, now abandoned.

(51) Int. Cl. G06F 17/30

(52) U.S. Cl. CPC G06F 17/30867
USPC 707/769

(57) ABSTRACT

Embodiments of the present invention include information services, methods and systems to facilitate gathering and management of information by home users and professional users of information gathering, processing, and distribution services, and user interfaces through which users communicate with information services. In one embodiment of the present invention, a central information gathering, processing, and distribution service provides a simple, but robust and highly functional, interface to remote home users and professional users to allow the home users and professional users to continuously receive updated information gleaned from continuous searching of the Internet and other information sources by the information service. The interface allows users to define, refine, and stably store interests that define information searches continuously carried out, on behalf of the user, by the information gathering, processing, and distribution service. The information service discovers and stores user preferences, interests, and bookmarked URLs and other information in a way that allows users within communities of users to share their stored interests, bookmarked information, and preferences among themselves.

### CROSS-REFERENCE TO RELATED APPLICATION

This application is a continuation of application Ser. No. 11/234,405, filed Sep. 23, 2005.

### TECHNICAL FIELD

The present invention is related to methods and systems that gather, process, compile, and distribute information and, in particular, to a community-based information gathering, processing, and distribution system and method that allows users to tailor the information that they receive, to share information within a community or communities of users, to receive information on various different information-rendering devices, and to access user-managed information stably stored within the data storage facilities of a remote information service.

### BACKGROUND OF THE INVENTION

Advances in science and technology during the past 150 years have provided an amazing array of new products, services, and technologies in a wide variety of fields of human interest and need and have provided immeasurable benefit to people throughout the world. During that time span, human society has evolved from a largely agrarian society, with rudimentary knowledge and understanding of basic sciences, to a largely urban, highly interconnected society possessing deep and detailed scientific and technical knowledge. Progress is readily apparent in any number of different fields, from basic physics, chemistry, mathematics, and biology, to the applied fields of electronics, medicine, transportation, and many others. Of all fields and areas of human interest, perhaps the most astonishing progress has been made in communications technologies and technologies and scientific understanding related to information, information gathering, information processing, and information dissemination. Whereas, 150 years ago, people largely depended on exchange of written correspondence and printed publications for communications, with low bandwidth transmission of information by telegraph used for communicating extremely concise, high priority information, people today have instantaneous access to text-based, graphical, video and audio, and computer-executable information from essentially countless locations in every country of the world.

FIG. 1 abstractly illustrates the amount of information generally available, at minimal cost, in homes and workplaces of modern, developed countries. Information is available from television broadcasts 102, the Internet, via personal computers (“PCs”) 104, radio broadcasts 106, and from other people via person-to-person communications, including wire-based and wireless telephone communications 108. The amount of information available is simply staggering. Home viewers can access tens to many hundreds of different television channels, each represented in FIG. 1 as a series 110 of programs, such as the first program 112, sequentially broadcast throughout each day. Each program may include a lengthy script, dialogue, music, and hundreds of different video clips and still images. A far greater amount of information is accessible through the Internet. A home PC user may access millions of different websites, each website containing a handful, tens, hundreds, or thousands of different web pages, such as web page 114, each web page containing textual, graphical, and animated or video information, and additionally containing hyperlinks to other websites and individual web pages provided by the linked websites and web pages. Similarly, a person may access hundreds of different radio channels, each radio channel providing sequential broadcast of tens to hundreds of programs per day. Interpersonal communications technologies, such as cell phones, email, and other technologies allow people to share information amongst themselves, including information about broadcast and Internet-served information accessible by television, web browsers running on PCs, and radio. Unfortunately, although communications technology has evolved to the point that a person can access more information, at any given instant in time, than the person could hope to manually process in an entire lifetime, human abilities for assimilating and managing information have progressed only modestly, at best, during the past 150 years.

Perhaps the most popular and powerful current technique for accessing and managing information is that accessing web pages, via the Internet and a PC, using search engines. Search engines generally provide a web-page-based interface to allow search-engine users to input queries and to receive results from those queries displayed on one or more result web pages. FIGS. 2A-C illustrate a simple example of use of a search engine to obtain information. FIG. 2A shows an initial search-engine interface comprising a web page 202 displayed to a user by a web browser running on the user's PC. The search page includes a text-entry field 204 that allows a user to input various key words to define an information search. As shown in FIG. 2B, a user has input the words “witch” and “doctor” to the text-input field 204 to define a search, has maneuvered a graphical cursor 206 to overlay a search-initiation button 208, and then inputs a mouse click to the web browser in order to execute the search defined by the words “witch” and “doctor.” The input words are transmitted by the web browser to a remote search engine, which conducts a search based on a large amount of compiled information, indexes, and other data structures continuously maintained by the search engine based on continuous access to millions of different web pages. The search engine produces a list of universal resource locators (“URLs”) that specify web sites and web pages determined by the search engine to contain information related to the key words input by the user. FIG. 2C shows results returned by a remote search engine and displayed to a user through the user's web browser. The returned results generally comprise a list of displayed links, corresponding to URLs, each link annotated with an English-language name and with a brief summary or encapsulation of the information contained in the web site or web page addressed by the URL associated with the link. For example, as shown in FIG. 2C, the example search engine has returned a list of links associated with the input search keywords “witch” and “doctor.” The first eight links in the list of links returned by the search engine are displayed on the search page. Each link includes an underlined natural-language title, such as the title “Innovations in Community Health” 210, along with a synopsis of the web site or web page 212, often displayed in a truncated form that can be expanded via a mouse click or other user input. A user can display the contents of the web site or web page corresponding to the link by steering a graphical cursor to overlie the underlined natural-language title, and inputting a mouse click. An input mouse click prompts the web browser to access the web site or web page identified by the URL corresponding to the displayed link. The web browser uses the URL to access a remote web server and obtain a hypertext markup language (“HTML”) file, or other formatted file, from the remote server for local rendering and display to the user on the user's PC.

Search-engine-facilitated information gathering has become the preferred tool for information gathering in homes and professional workplaces throughout the world. However, standard search-engine-based information gathering has many disadvantages. First, search engines generally return a very large number of links in response to the types and quantities of key words normally employed by search-engine users. A user may refine a search by adding more specific key words, but users generally employ inefficient, ad hoc, trial-and-error methods to refine a search to provide a useful list of web sites and web pages. Moreover, a user is never certain that the search engine has failed to identify a large amount of desired information, for a variety of reasons, including the fact that input key words may not literally match text included in desired web sites and web pages, despite the fact that the semantic content of the desired web sites and web pages is related to a semantic meaning of the input key words. Second, search-engine-based information gathering is generally user initiated. The Internet is extremely dynamic, and new information may become accessible through the Internet with every passing second. However, in order to access new information, a user generally needs to initiate a search, and to scan through a potentially voluminous amount of returned information to identify any new web sites or web pages accessible since the last time the search was executed. Third, although web browsers normally allow users to bookmark, or locally store, URLs and links of interest, the bookmarked links may be cumbersome to manage, may be difficult to share with others, and may be impossible to access from a different information rendering and display device, such as a television with an attached set-top box, than the device on which the links are stored. Fourth, search engines can generally search only Internet-connected information sources, and can only generally carry out relatively simple matching of keywords to words contained in text displayed on web pages, although many additional sources of information may provide useful and desirable information. For these reasons, and for many other reasons, information providers, information managers, information-service providers, and the many people who access information at home and in professional environments have all recognized the need for more functional and capable interfaces by which information can be gathered from the enormous amounts of information accessible via the Internet, television, and many other sources, and by which gathered information can be organized and managed.

### SUMMARY OF THE INVENTION

Embodiments of the present invention include information services, methods and systems to facilitate gathering and management of information by home users and professional users of information gathering, processing, and distribution services, and user interfaces through which users communicate with information services. In one embodiment of the present invention, a central information gathering, processing, and distribution service provides a simple, but robust and highly functional, interface to remote home users and professional users to allow the home users and professional users to continuously receive updated information gleaned from continuous searching of the Internet and other information sources by the information service. The interface allows users to define, refine, and stably store interests that define information searches continuously carried out, on behalf of the user, by the information gathering, processing, and distribution service. In one information-service embodiment of the present invention, the information service stores information gathered and processed according to user-specified parameters at a central site, to allow users to access the information from any number of different information-rendering-and-display devices. The information service discovers and stores user preferences, interests, and bookmarked URLs and other information in a way that allows users within one or more communities of users to share their stored interests, bookmarked information, and preferences among themselves. In one embodiment of the present invention, the information service provides a relatively small, easily understandable, highly functional interface to users that log into the information service. In one user-interface embodiment of the present invention, the user interface provides a small number of primary web pages, each web page accessed through a tab, that display and provide features and facilities for management of a user's interests, preferences, the one or more communities to which the user belongs, and updated information gathered according to the user's defined interests and preferences.

### BRIEF DESCRIPTION OF THE DRAWINGS

FIG. 1 abstractly illustrates the amount of information generally available, at minimal cost, in homes and workplaces of modern, developed countries.

FIGS. 2A-C illustrate a simple example of use of a search engine to obtain information.

FIG. 3 illustrates an architectural aspect of one embodiment of the present invention.

FIG. 4 shows fundamental, logical components employed and maintained by an information service according to one embodiment of the present invention.

FIG. 5 provides an abstract illustration of the web catalog constructed, maintained, and continuously updated by the information service in one embodiment of the present invention.

FIG. 6A shows an overview block diagram of web-catalog-update mechanisms used by an information service in one embodiment of the present invention.

FIGS. 6B-D illustrate one method by which the web crawler of embodiments of the present invention can carry out a limited search.

FIG. 6E shows a control-flow diagram of a continuous query routine that illustrates a continuous searching method employed in various embodiments of the present invention.

FIG. 7A illustrates a method embodiment of the present invention for extracting summary information from a file, such as an HTML file that specifies display of a web page.

FIGS. 7B-D provide a more detailed illustration of link-annotation extraction from a webpage or other information source.

FIG. 8 shows one interest hierarchy employed in various embodiments of the present invention.

FIG. 9 illustrates transformation of an interest, by an information service, into a list of URLs, or other specifiers for information accessible by the user in one embodiment of the present invention.

FIG. 10 illustrates the contents of an exemplary user profile of one embodiment of the present invention.

FIG. 11 illustrates a user community of one embodiment of the present invention.

FIGS. 12A-B provides a more detailed architectural diagram of one information-service embodiment of the present invention.

FIG. 13 shows a first screen capture of a web page displayed by a user-interface embodiment of the present invention.

FIG. 14 shows an expanded interest-adding region displayed on the My Interests web page of one embodiment of the present invention when a user undertakes adding an interest to the user's interests list.

FIG. 15 shows a pop-up menu displayed when a user clicks the square icon associated with an interest in the user's interests list according to one embodiment of the present invention.

FIG. 16 shows a screen capture of the My Interests web page of one embodiment of the present invention when the options pane is displayed.

FIG. 17 shows a screen capture in which the My News page of one embodiment of the present invention is displayed.

FIG. 18 shows a screen capture of a displayed Community page of one embodiment of the present invention.

FIG. 19 shows a display of other users with similar interests on the Community page of one embodiment of the present invention.

FIG. 20 shows a results set of interests that contain key words or URLs specified by the user through the search tools provided on the Community page of one embodiment of the present invention.

### DETAILED DESCRIPTION OF THE INVENTION

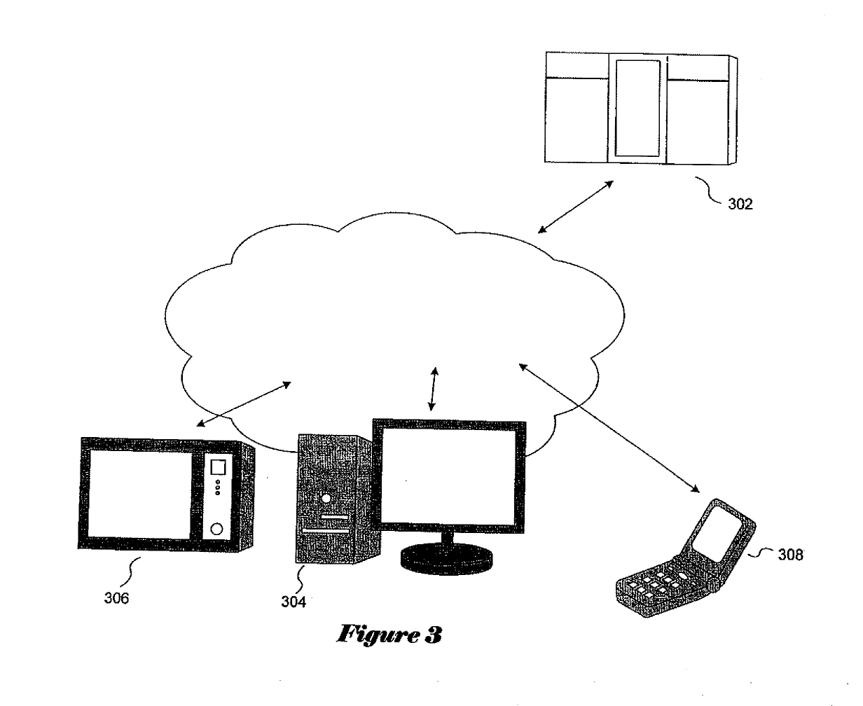

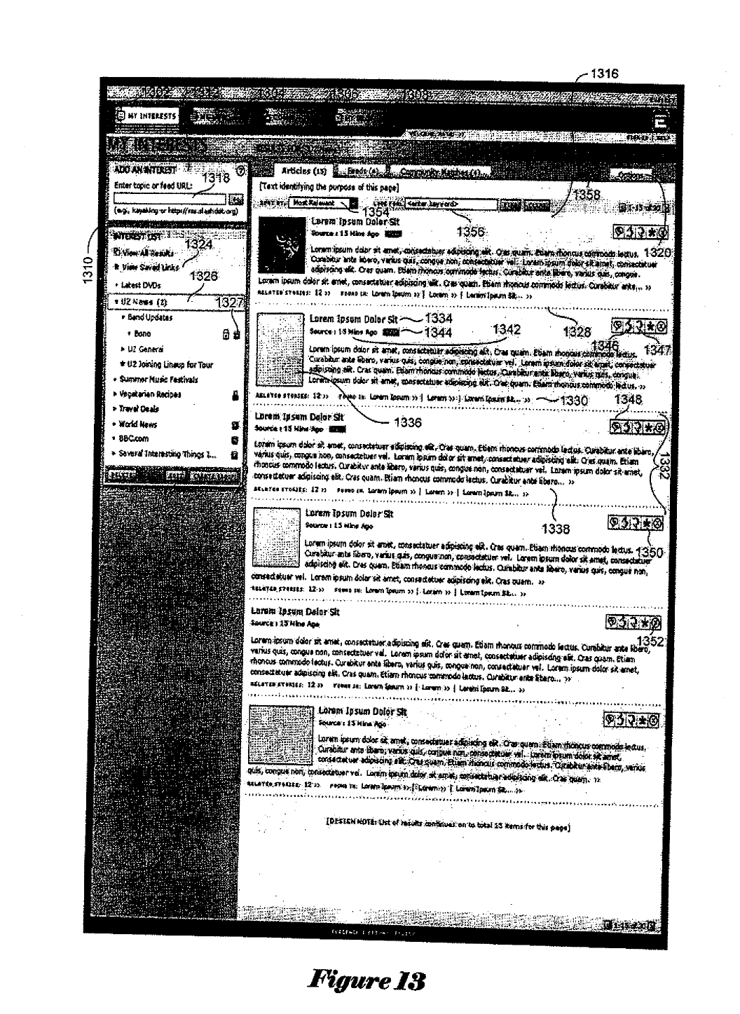

Embodiments of the present invention are directed to methods and systems employed by an information gathering, processing, and distribution service to facilitate distribution of information to users according to user-specified interests and preferences. Embodiments of the present invention include concise, but powerful and easily assimilated interfaces provided by the information service to users to allow users to specify, tailor, and refine information that they receive from the information service, to manage the received information, and to share information and preferences within one ore more communities of users. First, overview-level descriptions of the general approaches embodied in various embodiments of the present invention are presented, with reference to FIGS. 3-12. Then, a detailed discussion of one user-interface embodiment of the present invention is provided with reference to FIG. 13-20.

FIG. 3 illustrates an architectural aspect of one embodiment of the present invention. Various method and system embodiments of the present invention provide remote storage of user interests, bookmarks, archived web pages, preferences, and other information within a remote, centralized or distributed computing and data-storage system. The remote computing and data-storage system is represented in FIG. 3 as a large computer system 302. Because a user's interests, preferences, bookmarked links, archived web pages, and other user-specific information are stored remotely from a user's PC 304, the user can access all or a portion of the user's preferences, bookmarks, archived web pages, interests, and other stored information from a variety of different information-rendering-and-display devices, including the PC 304, a television, 306 a set-top box, a cell phone 308, and many other types of electronic devices that provide for display of information.

The amount of information accessible from an information rendering and display device depends on the information rendering and display capabilities of the device. In general, higher-end, centralized or distributed computer systems and data-storage systems are more robust and reliable, with two-fold or greater-fold redundancy of critical components, including power supplies, so that a user's stored information is always available. Currently, bookmarks and other such information are generally stored locally, on a user's PC. Should the PC fail, the user may not be able to recover the stored information. Furthermore, different types of non-PC information-rendering-and-display devices, such as set-top boxes, televisions, and cell phones, cannot be conveniently interconnected with a PC to allow information stored within the PC to be accessed from a set-top box, television, or cell phone. Remote storage of user information also facilitates sharing of information between users within one or more user communities. By storing the bulk of user information on information-service computing facilities, the stored user information may be employed by information-service routines for more specifically targeting searches, refining searches, and automatically discovering user interests and preferences.

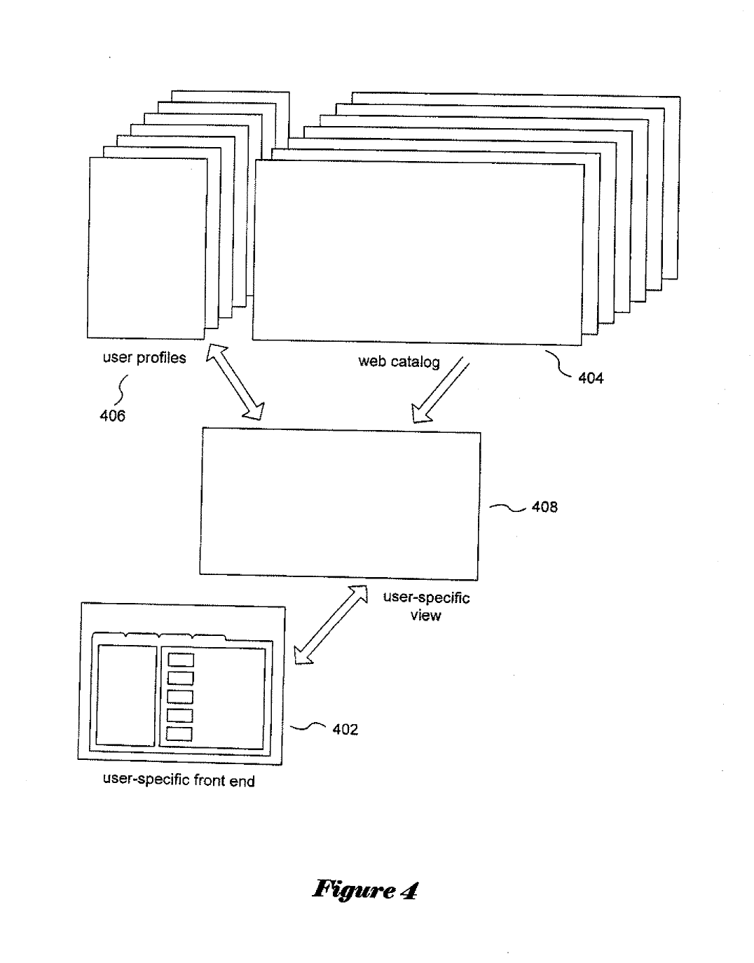

FIG. 4 shows fundamental, logical components employed and maintained by an information service according to one embodiment of the present invention. A user communicates with the information-service embodiment of the present invention through a user-specific front end 402 comprising a small set of web pages, organized into folders, that is dynamically constructed and updated on behalf of the user by the information service. This user interface is described, in greater detail, below. The user interface allows a user to receive information and allows a user to input and transmit information to the information service in order to specify interests, information to be stored, preferences, and to provide other information to the information service.

The information service constructs, maintains, and continuously updates a very large and complex web catalog 404 within information-service computing and storage facilities. The web catalog represents a large amount of compiled and indexed information gleaned by the information service from the Internet and other sources of information. The information service continuously searches and monitors a large number of web sites, web pages, and other information sources in order to collect new information used to update the web catalog so that the web catalog continuously reflects the current informational state of those information sources from which information is gathered on behalf of users. The information service uses starting points specified by the users and collects pages which are linked directly or indirectly from those starting points in a breadth-first manner up to a predetermined depth or number of pages. In this way the pages that are of most interest to the user are kept up-to-date in the catalog without expenditure of the considerable resources that would be needed to completely cover the entire internet.

The information service also constructs and maintains user profiles for each user of, or subscriber to, the information service. User profiles are discussed, in greater detail, below. For each user, or subscriber, the information service constructs a user-specific view 408 for each user, or subscriber, that dynamically represents a subset of the information content of the web catalog and user profiles that is of current interest to the user or subscriber. In other words, each user of the information service may have a different, specific view into the information gathered and maintained by the information service that is determined by the user's interests, preferences, information rendering and display capabilities of the user's devices, and other such criteria. The term “view” has a meaning similar, in the current context, to the meaning of the term “view” used in the context of relational databases. The user-specific front end, or user interface 402, can be similarly thought of as a further, locally instantiated view into the user-specific view 408 constructed, maintained, and updated by the information service on behalf of each user.

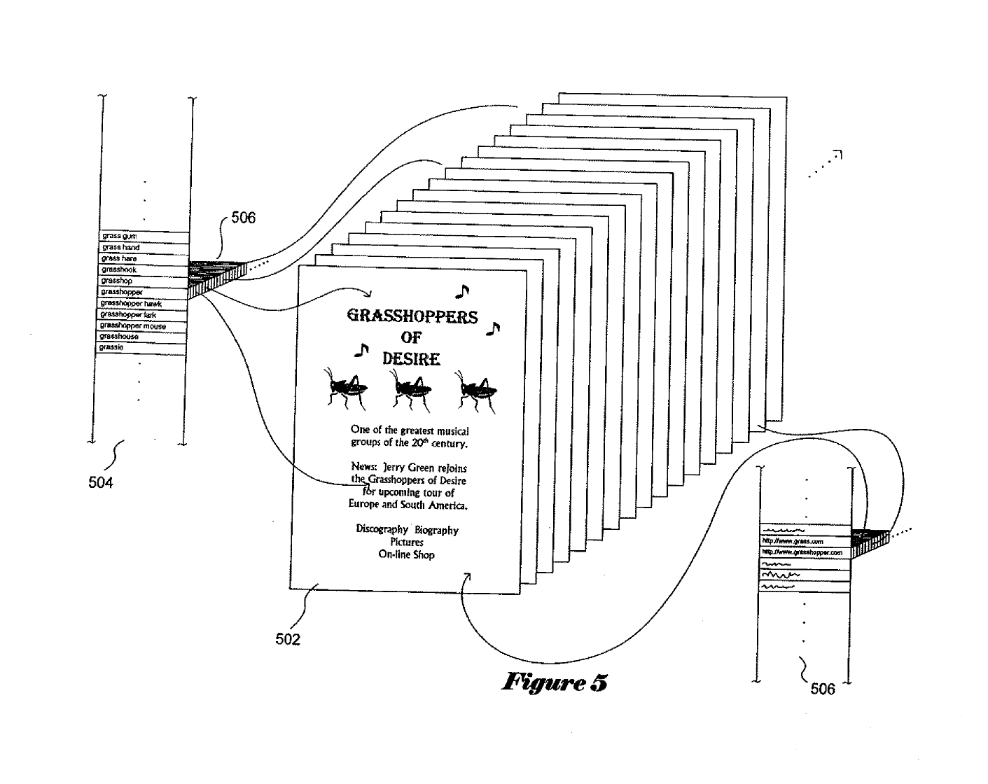

FIG. 5 provides an abstract illustration of the web catalog constructed, maintained, and continuously updated by the information service in one embodiment of the present invention. The web catalog comprises a very large amount of information compiled from the Internet, and other information sources. In FIG. 5, the compiled information stored in the web catalog is represented as a large array of pages, such as page 502. In general, however, the compiled information may be stored and organized using formats and storage conventions quite different from those used for encoding web page layouts and information content. The compiled information stored within the web catalog may, in certain embodiments, include URLs or other such specifiers for information accessible by the Internet or by other means, along with minimal descriptive information used to annotate displayed links representing the URLs to users. In alternative web catalogs, information gleaned from the Internet and other information sources is physically copied and stored in the web catalog, so that the information can be provided directly by the information service to the user, rather than requiring the user to separately access the information from various information sources, or requiring the information service to frequently return to the information sources to extract information in real time.

The web catalog further comprises a large number of indexes, such as the key-word index 504 and URL index 506 shown in FIG. 5. In the key-word index 504, all possible keywords are listed in alphabetical order, and for each key word, the index includes pointers to URLs, or to specific locations within information accessible through URLs, related to the key word. For example, as shown in key-word index 504, the key word “grasshopper” is associated with a long list of pointers 506 that reference specific URLs or web pages, sentences, or specific locations within the information accessible from a URL. Similarly, the URL index 506 includes the different URLs used as information sources by the information service, each URL associated with pointers to various different portions of the compiled information stored within the web catalog. Use of numerous different indexes allows the information service to rapidly and efficiently search the web catalog according to different types of searches specified by users. For example, the two indexes shown in FIG. 5 allow the information service to efficiently search the web catalog for information that includes, or that is related to, particular key words and/or particular URLs. Information services normally maintain many tens, hundreds, or more different indexes, the indexes often hierarchically structured and often multidimensional to provide varying granularities of searching and information retrieval and efficient searching in multiple search dimensions.

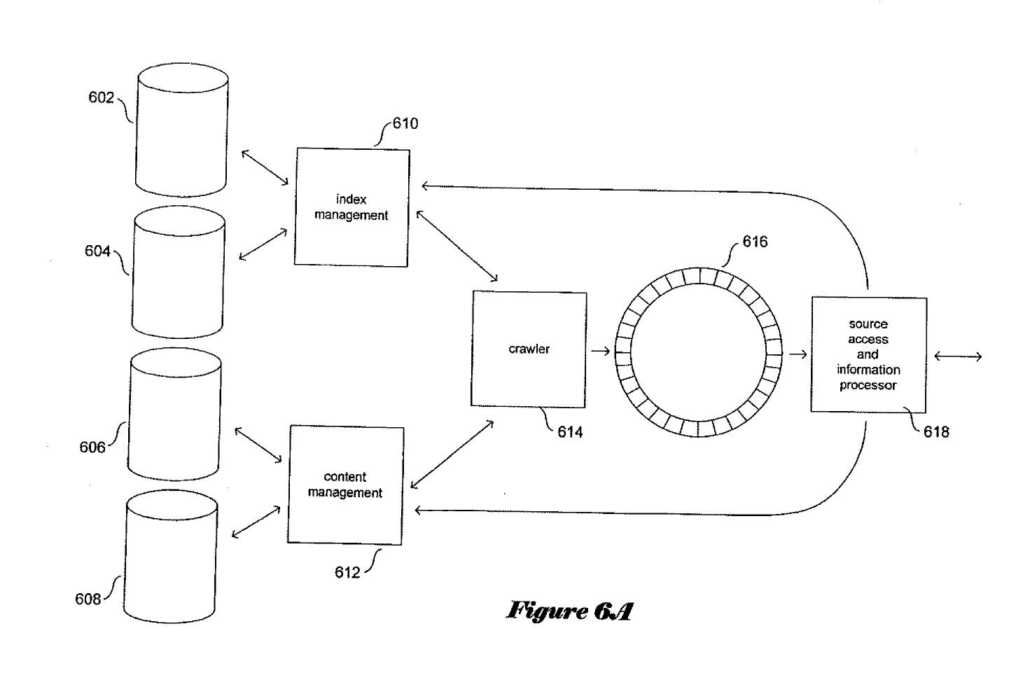

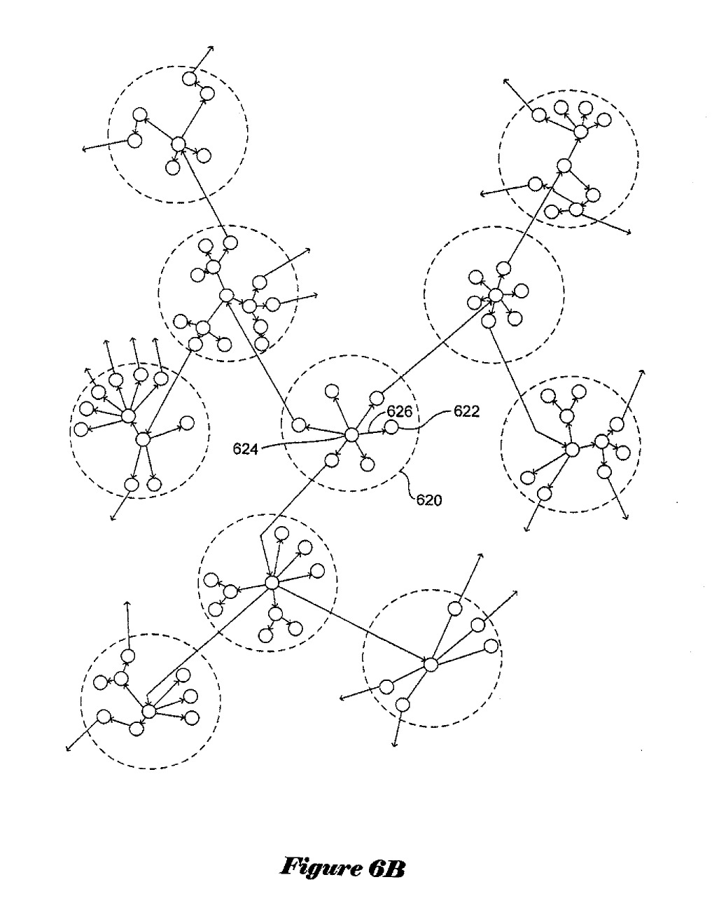

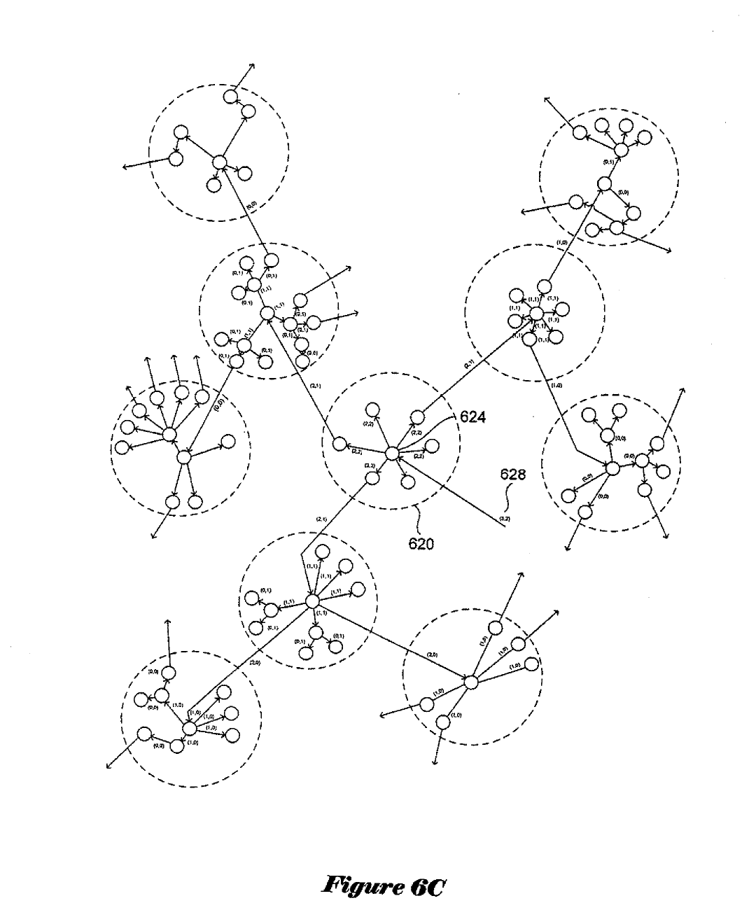

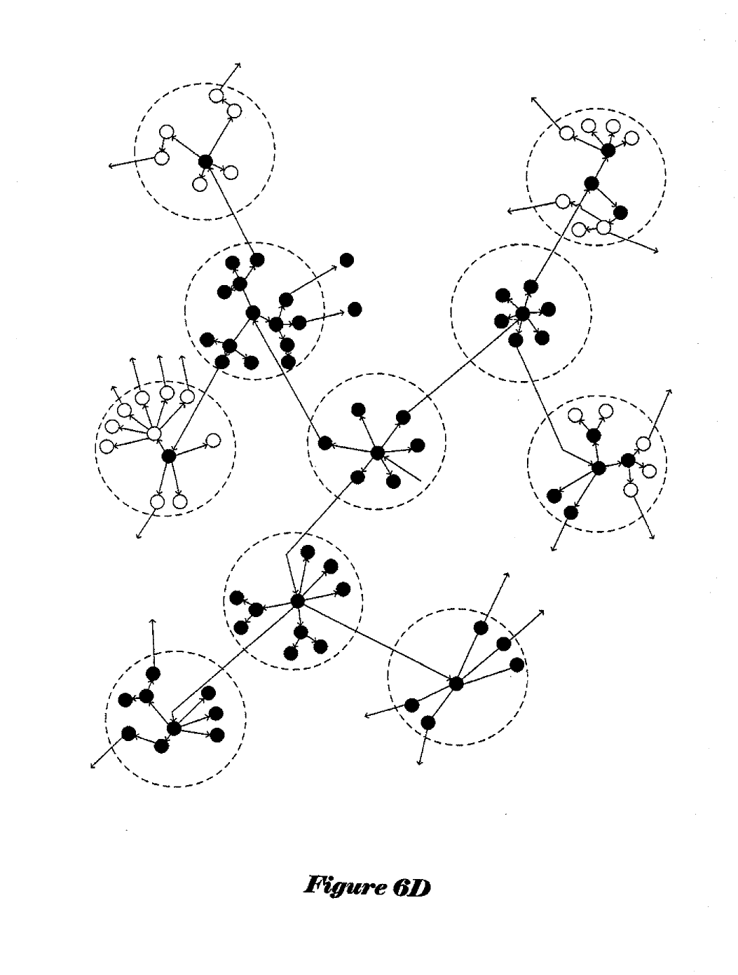

FIG. 6A shows an overview block diagram of web-catalog-update mechanisms used by an information service in one embodiment of the present invention. As shown diagrammatically in FIG. 6, the indexes of a web catalog may be stored in a first set of one or more databases or file systems 602 and 604, and the compiled content maintained by the web catalog may be stored in a second set of one or more databases or file systems 606 and 608. The indexes are managed and updated by a set of index-management routines 610, and the compiled content is managed and updated by a set of content-management routines 612. A web crawler 614, generally a large number of parallel web-searching routines, continuously operates within the computing facilities of the information service to monitor information sources, discover new information sources, and continuously update both the indexes and the content that together comprise the web catalog using information obtained from the information sources. The web crawler continuously queues information-retrieval requests onto one or more information-retrieval-request queues 616. The information-retrieval requests direct a large set of concurrently executed information-accessing-and-processing routines 618 to retrieve information from information sources, process the retrieved information, and furnish processed information in suitable formats to the content management 612 and index management 610 routines for updating the indexes and the stored content of the web catalog.

One feature of the web crawler employed in an information-service embodiment of the present invention is referred to as “polite spidering.” The information service queues information-retrieval tasks onto the one or more information-retrieval-task priority queues 616 containing entries for websites from which pages may be retrieved. The tasks are scheduled to minimize the computing resources and time spent by the web crawler to access and download information from remote information sources, but, at the same time, maximizing the information retrieved by the information service. The web crawler operates in order to maintain the number of accesses made by information-accessing-and-processing routines 618 to any particular web server, or other information source, at or below a defined access threshold for a given interval of time. In other words, the web crawler can be configured to direct access to particular information sources no more than a specified number of times per specified time period. In general, web servers and other such information sources monitor access to the information that they serve, and frequently refuse further access to accessors that too frequently access information provided by the information source. This allows information sources to thwart denial-of-service attacks and to attempt to provide fair information distribution among cooperative accessors. However, such strategies are problematic for web crawlers used by information services that need to continuously update web catalogs used by the information services to execute search requests. By limiting the number of accesses made to each information source, the web crawler employed by information-service embodiments of the present invention avoids being classified as a too-frequent information accessor by web servers and other information sources. This self-restrained information-source access, or polite spidering, approach used by a web crawler in various embodiments of the present invention is particularly useful for a catalog-based information service that monitors and accesses a smaller set of information sources than a general web crawler, which, lacking a catalog to update, may be tasked with accessing as many different websites and other information services as possible. Without polite spidering, the more focused searching of the web crawler in various embodiments of the present invention would tend to concentrate a greater number of accesses on a comparatively small number of information sources, further exacerbating the problems addressed by polite spidering.

Crawling of web pages may directed by a user, inputting a particular website address or other source point through the user interface, or may be automatically initiated by the information service. In either case, it may be important to limit the extent to which links in the initial source are traversed to find additional information sources. Otherwise, the crawler could continue to search for far longer, and expend far greater resources, than desired by either the user or information service. FIGS. 6B-D illustrate one method by which the web crawler of embodiments of the present invention can carry out a limited search. FIG. 6B shows a small portion of a search space. Each website is abstractly represented in FIG. 6B, and in FIGS. 6C-D, discussed below, by a dashed circle, such as dashed circle 620, and each web page within a website is abstractly represented as an unfilled circle, such as unfilled circle 622 that represents a web page within the website represented by dashed circle 620. The search is presumed to start at a defined point, in the case of FIG. 6B, at web page 624. Each directed edge, such as directed edge 626, represents traversal of a link included in a first web page to a second web page. For example, edge 626 represents traversal of a link embedded in web page 624 to access web page 622. A complete search space would include all web pages that could be eventually accessed from a starting web page. The search space starting from a webpage with only a few links can easily include millions of different web pages. Note also that, in FIGS. 6B-D, the paths along edges are acyclic, leading outward to new web pages, but actual search spaces may include many layers of cycles, and the paths may form a network or graph rather than an acyclic tree.

A search limiting technique used in various embodiments of the present invention is to recursively search a search space from a starting web page, and to launch a recursive thread, or call, for each link discovered in the starting web page. Each recursive thread, in turn, launches another recursive thread, or call, for each link discovered in the web page accessed through the link passed to the recursive thread. Each recursive call is therefore passed a link, but is also passed a distance/radius allocation, represented as a pair of integers (D,R). With each recursive call, either the distance or radius allocation is decremented. When a recursive thread, or call, decrements the received distance/radius allocation and produces a distance/radius allocation equal to (0,0), the recursive thread or call terminates, without launching another recursive thread or call. The search is launched with a particular distance/radius allocation that limits the ultimate extent of the search.

FIG. 6C shows the distance/radius allocation pairs (D,R) generated for each recursive call, or launch of a recursive thread, during a crawl of the search space shown in FIG. 6B. Initially, the search is called with a distance/radius allocation pair (D,R) equal to (3,2) 628. From the initial web page 624, 6 recursive calls can be made, or 6 recursive threads can be launched. Because all 6 recursive calls involve links within the same website 620, the distance allocation is decremented for each, so that each recursive call receives a distance/radius allocation pair (D,R) equal to (2,2). A recursive call to an intra-website webpage preferentially involves decrementing the distance allocation D, but if D is 0, and the radius allocation R>0, then R may be decremented. However, a recursive call involving an inter-web site link necessarily decrements R, and is not made if R=0. FIG. 6D shows, as filled circles, all of the web pages accessed in a limited, recursive search starting from webpage 624 with a distance/radius allocation pair (D, R) equal to (3,2).

A pseudo code limited-search crawl is next provided, to further illustrate the crawler embodiment described above with reference to FIGS. 6B-D:

| | |
|---|---|
| 1 | crawl (int D, int R, link s) |
| 2 | { |
| 3 | link t; |
| 4 | if (process(s)) |
| 5 | { |
| 6 | while (t = s.getNextOutlink( )) |
| 7 | { |
| 8 | if (t.in(s)) |
| 9 | { |
| 10 | if (D + R > 0) |
| 11 | { |
| 12 | if (D > 0) crawl (D−1, R, t); |
| 13 | else crawl (D, R−1, t); |
| 14 | } |
| 15 | } |
| 16 | else |
| 17 | if (R > 0) crawl (D, R−1, t); |
| 18 | } |
| 19 | } |
| 20 | } |
| 21 | } |

The routine “crawl” receives the distance allocation D, radius allocation R, and a link s as arguments. On line 4, the routine “crawl” calls a processing routine to process the webpage addressed by the link s, and the processing routine returns a Boolean value TRUE if the routine “crawl” has not previously processed the web page. In the while-loop of lines 6-19, the routine “crawl” extracts each link from the webpage addressed by the link s. If the currently considered extracted link t is in the same website as the link s, as determined on line 8, then if the distance/radius allocation is not (0,0), as determined on line 10, a recursive call to the routine “crawl” is made, preferentially decrementing the distance allocation D, on line 12, but, if necessary, decrementing the radius allocation R, on line 13. Otherwise, if the currently considered extracted link t is not in the same website as the links, then if the radius allocation is not 0, as determined on line 17, a recursive call to the routine “crawl” is made, also on line 17.

In general, the information service conducts continuous searching, generally through many parallel search threads, in order to continuously update searches, or interests, on behalf of users of the information service. In many embodiments of the present invention, the continuous searching is inverted, with newly discovered or recently updated webpages and other information sources matched to relevant user queries, or interests, and the relevant user queries or interests subsequently updated. FIG. 6E shows a control-flow diagram of a continuous query routine that illustrates a continuous searching method employed in various embodiments of the present invention. In FIG. 6E, the routine “continuous query” executes a continuous do-loop of steps 630-640. In step 631, a crawler is invoked to identify new or newly updated webpages and other information sources. Next, in the for-loop of steps 632-638, the information sources returned by the crawler are processed. The currently considered information source is parsed into elements, in step 633, and each element is processed in the for-loop of steps 635-637. An element is a predefined unit of information, such as a tag and all text associated with the tag, or a block of text with a common formatting. Alternative implementations may use alternative definitions of elements for different types of information sources. In step 635, the user queries, or interests, related to the currently considered element are identified by searching a lookup table or index that relates elements to user queries or interests. Note that, in general, such user queries are found, since the searches conducted by the crawler are directed by user queries. Related user queries are added to a cache, in step 636, along with information extracted from the concurrently considered information source needed to eventually update the related user queries. Once all information sources returned by the crawler have been processed in the for-loop of steps 632-638, the accumulated update information stored in the cache is thresholded, in step 639, to select those updates of sufficient weight to warrant updating user queries, or interests. Finally, in step 640, the caches update information is used to update relevant user queries, or interests.

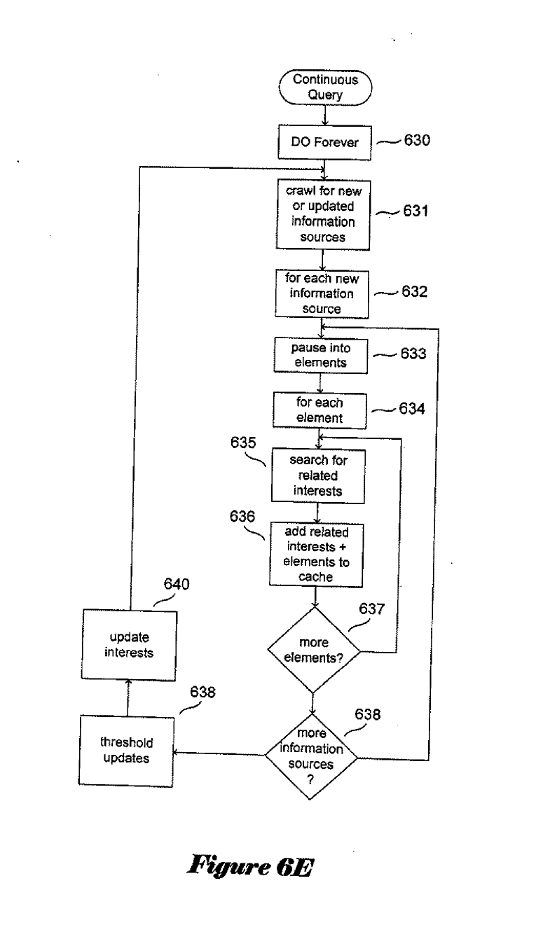

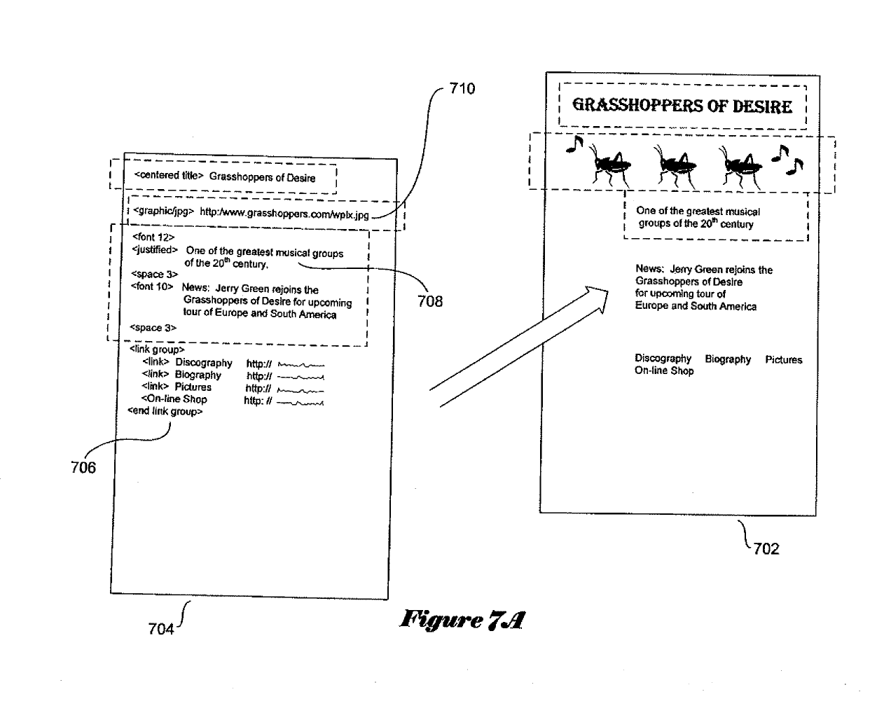

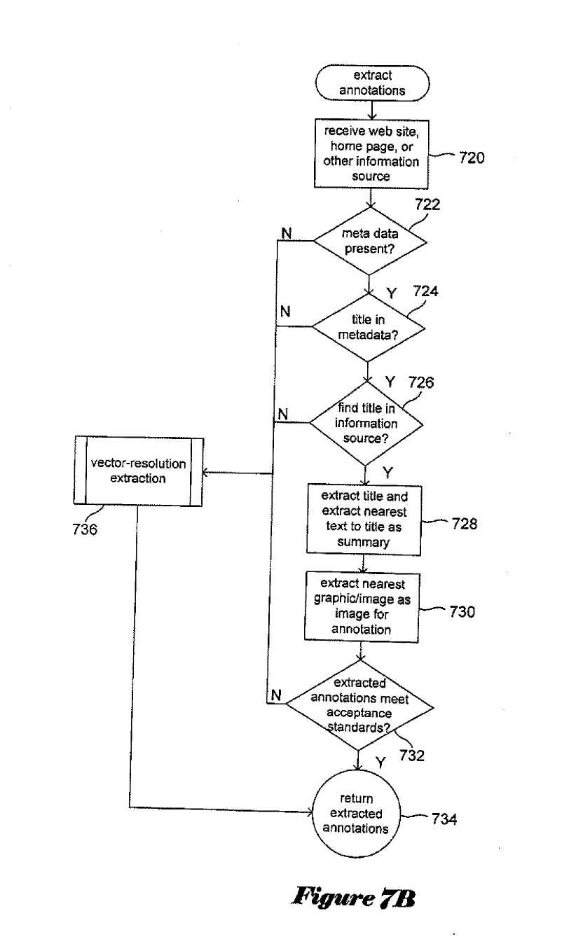

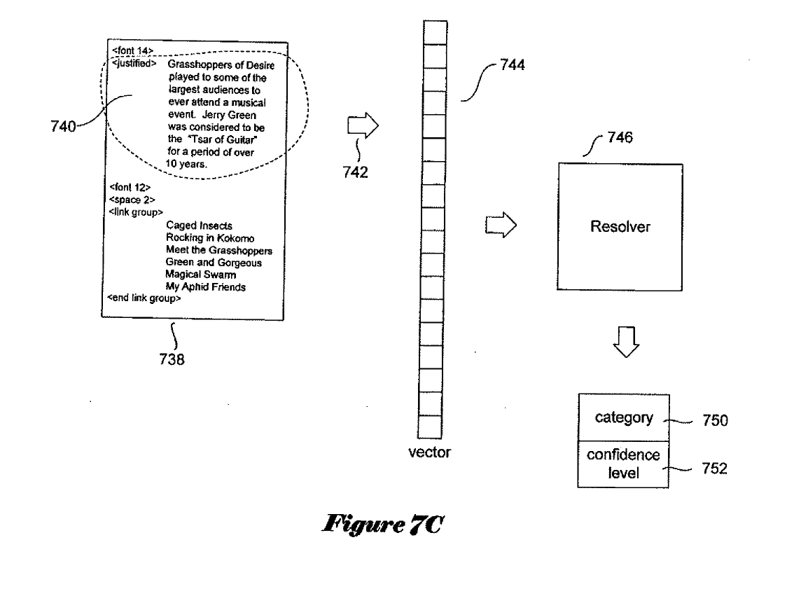

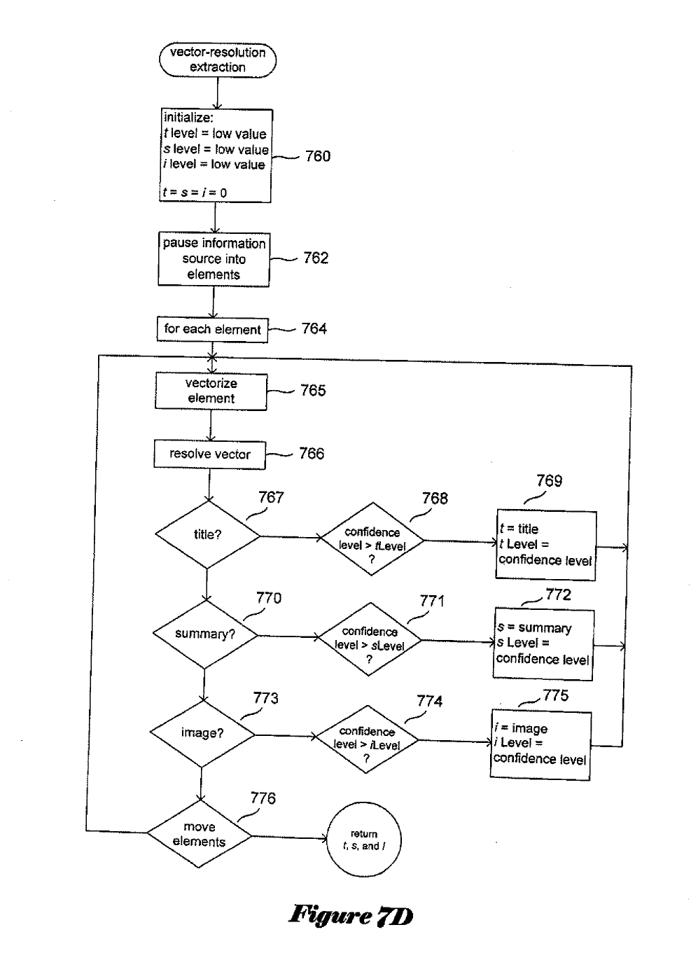

In general, the information-accessing-and-processing routines 618 that gather information from information sources attempt to gather sufficient information from a web page, web site, or other information source in order to provide an adequate summary of that information with which to annotate a displayed link representing the information to a user. Because of the large number of information sources continuously monitored by the information service, gathering of summary information needs to be done in a fully automated fashion. Embodiments of the present invention include an information-accessing-and-processing routine, and methods used by the information-accessing-and-processing routine, for extracting a title, picture or graphic, and summary sentence or paragraph from each accessed web site or web page to serve as a displayed annotation, or summary, for a link to the web site or web page displayed to a user as part of a search result. FIG. 7A illustrates a method embodiment of the present invention for extracting summary information from a file, such as an HTML file, that specifies display of a web page. As shown in FIG. 7, a displayed web page 702 is normally encoded in a text file 704 that includes tags or commands, such as tag 706, text, such as the sentence 708, and URLs or other location specifiers, such as URL 710, from which graphical and other non-text information can be obtained for display within the web page. The particular tags and commands shown in the example web-page specification 704 in FIG. 7 are not HTML tags and commands, and are provide an illustration of a generalized web-page specification to facilitate discussion of the method embodiment of the present invention for extracting summary information.

Although much of the current discussion concerns searching for and displaying annotated links to Internet-based information sources, the information service may also process and present other types of information to users. For example, the information service may search electronic program guide information. Electronic-program-guide information matching user's interests may then be downloaded to a digital video recorder to allow the digital video recorder to be scheduled to record the corresponding program or programs. Alternatively, the information may downloaded to a set-top box to allow for display of program information or to render the programs on a television at the appropriate time.

In the method embodiment of the present invention, a machine-learning system is trained to recognize various patterns and characteristics of web page specifications in order to identify, within a web page, a title, a graphic or picture, and summary sentences or a summary paragraph suitable for inclusion in an annotation for, or summary of, the information contained in the web page specified by the web page specification. For example, suitable titles may generally serve as arguments for particular formatting commands, and may commonly occur at or near the beginning of the specification. Summary sentences and paragraphs may be recognized by proximity to the title, by the information content of the words of the sentence or paragraph with respect to the information content of the entire specification, by statistical analysis of the word occurrences in each candidate summary sentence or paragraph, and by other characteristics. Thus, the information-accessing-and-processing routines employ extraction techniques that are, at least in part, created and refined by machine learning processes to recognize a fingerprint of commands and tags, locations, relationships between text and commands and between commands, statistical features, and other features and characteristics to recognize suitable titles, graphics, and summary sentences or paragraphs for preparing summaries with which to annotate displayed links, without needing to attempt full natural language processing, or semantic understanding of, the content of the web sites or web pages, in order to identify suitable summary information.

FIGS. 7B-D provide a more detailed illustration of link-annotation extraction from a webpage or other information source. FIG. 7B shows a control-flow diagram of the routine “extract annotations,” which represents on embodiment of the present invention. In step 720, the routine “extract annotations” receives a website or other information source, addressed by a link for which annotations need to be extracted for display to a user. In step 722, the routine “extract annotations” determines whether metadata is present within the information source. If metada is present, then, in step 724, the routine “extract annotations” determines whether or not the metadata includes a title. If the metadata does include a title, then, in step 726, the routine “extract annotations” determines whether the title included in the metadata can be found in the text included in the information source. If so, then, in step 728, the routine “extract annotations” extracts the title from the information source to use as a title annotation and extracts text in close proximity to the title as a summary annotation. Additional metrics and techniques may be employed in step 728 in order to extract a suitably formatted title and a coherent set of sentences both near the title and related to the title, as the summary annotation. Then, in step 730, an image near the title in the information source is extracted as the image annotation, if such as image can be found. In step 732, the extracted title, summary, and image annotations are verified for quality and appropriateness, using various evaluation techniques, and, if the extracted title, summary, and image annotations are evaluated as acceptable, then they are returned. However, should any of the conditional steps 722, 724, 726, or 732 fail, then a vector-resolution extraction routine is called, in step 736, to extract title, summary, and image annotations from the information source.

FIG. 7C illustrates vector-resolution-based annotation extraction. In FIG. 7C, a formatted information source 738 is first parsed to extract elements, such as the element 740 marked by a dashed circle in FIG. 7C. An element may be defined by various parsing methods to be a unit of information, as determined, in part, by the presence of tags, formatting conventions, or by other indications. Each extracted element is then vectorized 742 to produce a metrics vector 744. Vectorization involves analyzing the element with respect to the information source in order to determine the values for various metrics vector elements. Metrics vector elements may include one or more of (1) a similarity metric indicating similarity of the element to a metadata-included title, or some other known data; (2) a metric derived from the word count of the element; (3) a metric derived from statistical analysis, or table-lookup-based analysis, of the text contents of the element; (4) a metric derived from punctuation or formatting patterns found in the element; (5) additional similarity metrics comparing text in the element to a domain name, website name, URL, or other such information; (6) metrics derived from attributes or tags found in the element; (7) distances, in characters or other units, of the element to other elements or points in the information source; and (8) metrics derived from other features and characteristics of the element, contents of the element, position of the element within the information source, features and characteristics of the information source, and comparisons of the element and/or information source to information stored in tables, files, databases, or other information repositories. Finally, the vector is submitted to a resolver 746 which processes the vector to output a two-element result vector 748 containing a value 750 that indicates the category of the element, such as “title annotation,” “summary annotation,” “image annotation,” or “unknown,” and a value 752 that indicates a confidence level assigned to the result vector. The resolver may be a neural network, rule-based inference engine, or some other trainable software, hardware, or software/hardware entity that can be trained to classify elements.

FIG. 7D shows a control-flow diagram for the routine “vector-resolution extraction” called in step 736 of FIG. 7B. In step 760, the routine “vector-resolution extraction” initializes three variables tLevel, sLevel, and iLevel, representing the largest observed confidence levels for candidate title, summary, and image annotations, to 0, and initializes the pointers t, s, and i to null. Next, in step 762, the routine “vector-resolution extraction” parses the information source to extract elements from the information source. In the for-loop of steps 764-777, each element is evaluated as a candidate annotation. First, the currently considered element is vectorized, in step 765, as described above with reference to FIG. 7C. Then, in step 766, the metrics vector corresponding to the element is resolved, as described above with reference to FIG. 7C. If the result vector indicates that the element is a title annotation, and if the confidence level included in the result vector is greater than any previously observed title-element-candidate confidence level, as determined in steps 767 and 768, then, in step 769, a local variable t is set to point to the element, and the candidate confidence level tLevel is updated to the confidence level included in the result vector. Otherwise, if the element is indicated to be a summary annotation, and if the confidence level included in the result vector is greater than any previously observed summary-element-candidate confidence level, as determined in steps 770 and 771, then, in step 772, a local variable s is set to point to the element, and the candidate confidence level sLevel is updated to the confidence level included in the result vector. Otherwise, if the element is indicated to be an image annotation, and if the confidence level included in the result vector is greater than any previously observed image-element-candidate confidence level, as determined in steps 770 and 771, then, in step 772, a local variable i is set to point to the element, and the candidate confidence level iLevel is updated to the confidence level included in the result vector. Finally, the variables t, s, and i are returned as pointers to the best candidate title, summary, and image annotations, with a null pointer representing the fact that no candidate annotation was found.

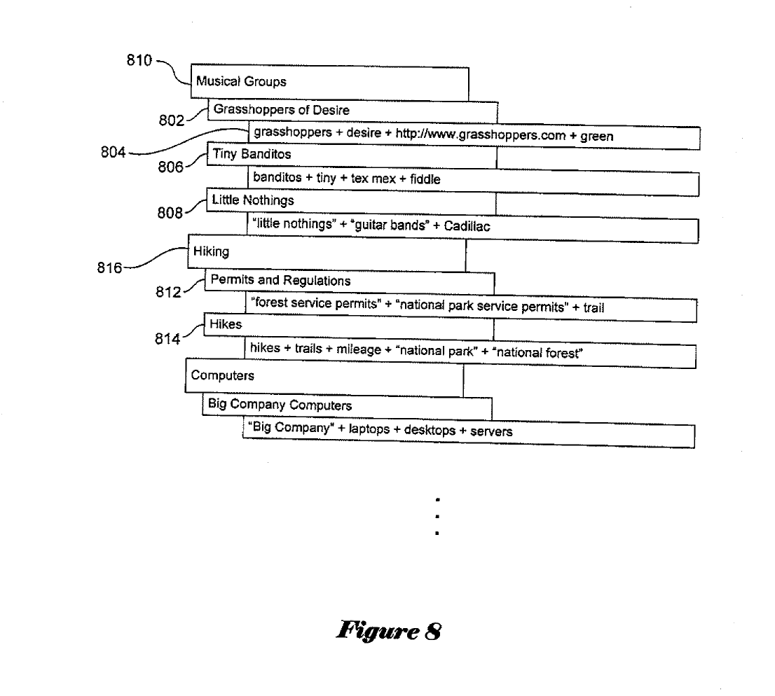

In one embodiment of the present invention, a fundamental logical entity defined, stored, maintained, and employed both by the information service and by a user of the information service is referred to as an “interest.” From a user standpoint, an interest can be thought of as a topic or category of information that the user wishes to access and about which to be continuously informed by the information service. FIG. 8 shows one interest hierarchy employed in various embodiments of the present invention. Each interest is identified by a name, or text string, such as the interest name “Grasshoppers of Desire” 802 in FIG. 8. An interest, in many embodiments of the present invention, comprises a search string associated with the interest. For example, in FIG. 8, the search string 804 is associated with the interest “Grasshoppers of Desire.” The search string associated with an interest defines the information corresponding to the interest. For example, in the example shown in FIG. 8, the interest “Grasshoppers of Desire” is a list of annotated links found by the information service when the information service searches the web catalog using the search string 804. In many embodiments of the present invention, a search string may consist of any number of individual key words, separated by spaces or operators, as well as URLs or other specific indications of information sources.

Interests may be further categorized into categories, or interest groups. A user can store multiple persistent searches as well as bookmarks within an interest group, to facilitate both the management of the interests as well as to provide cohesive, automatically updated display of the topic represented by the interest group, and monitored on behalf of the user by the information service. Interest bookmarks are more powerful than the standard, passive bookmarks encountered in standard Internet search engines. Interest bookmarks are monitored by the information service on behalf of a user, and a bookmark is visually updated by the information service to indicate that new or updated information related to the bookmark is available. By contrast, a user needs to repeatedly check, or poll, a standard bookmark to discover newly available or newly updated information related to the bookmark. For example, as shown in FIG. 8, the interests “Grasshoppers of Desire” 802, “Tiny Banditos” 806, and “Little Nothings” 808 are all contained within the interest group “Musical Groups” 810. Similarly, the interests “Permits and Regulations” 812 and “Hikes” 814 are both contained in the interest group “Hiking” 816.

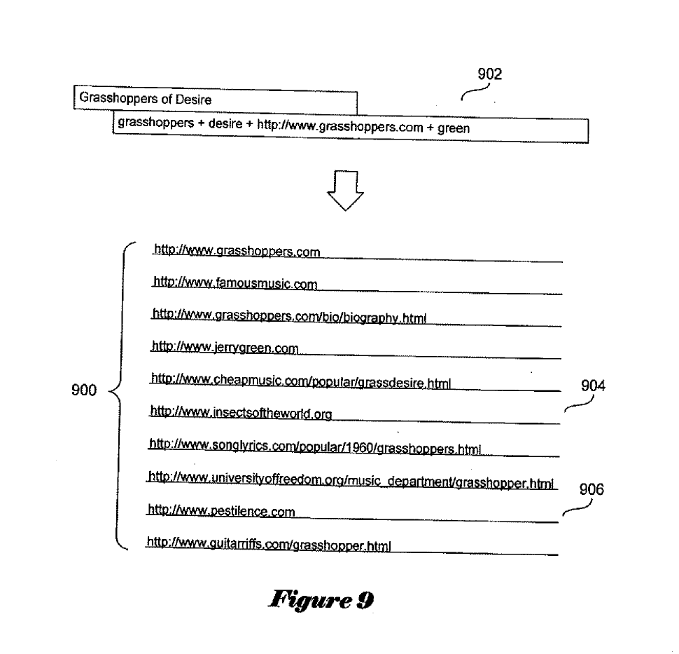

Users specify their interests using tools provided by the user interface. The information service stores a user's interests within a user profile maintained by the information service on behalf of the user. FIG. 9 illustrates transformation of an interest, by an information service, into a list of URLs, or other specifiers for information accessible by the user in one embodiment of the present invention. One advantage provided by information services that represent embodiments of the present invention is that the initial list of URLs, or other information-source specifiers, may be refined by the user using tools provided by the user interface. For example, as shown in FIG. 9, the first ten URLs in the results set generated by the information service in response to executing a search based on the interest “Grasshoppers of Desire” 902 contains several URLs 904 and 906 that appear not to be related to the musical group “Grasshoppers of Desire” that is the object of the interest “Grasshoppers of Desire.” The user interface allows the user to modify either the interest 902 or the results set 900 so that, in the future, the results set more closely reflects the information desired by the user. Another advantage provided by many embodiments of the present invention is that the user may direct the information service to immediately search URLs, or other information-source specifiers, when processing an interest, rather than to rely solely on compiled information stored within the web catalog. This allows a user to more precisely develop specifications for interests that are stored and continuously employed by the information service to update information gathered on behalf of users.

FIG. 10 illustrates the contents of an exemplary user profile of one embodiment of the present invention. As shown in FIG. 10, a user profile 1002 typically includes: (1) a list of interests 1004 specified by the user, including both the names and associated search strings, in certain embodiments refined and supplemented by machine-learning components of the information service; (2) a list of bookmarked links, or, in other words, URLs 1006, and other information-source specifiers, of interest to the user and maintained by the user for subsequent access; (3) a list of interests 1008, developed by other members of the community, to which the user is subscribed to; (4) user preferences 1010 specified by the user and discovered on behalf of the user and suggested to the user by the information service; (4) user information 1012, including user passwords and other login information, address, billing address, and other such information; and (5) a list 1014 of connections, or information-rendering-and-display devices, including their addresses and rendering and display capabilities, through which the user may access information gathered and processed for the user by the information service. Additional types of information may also be stored in user profiles in various embodiments of the present invention. User profiles may be encoded in various different formats and stored in databases, memory caches, file systems, and in many other information-storage media. In certain embodiments, a single user profile is created, stored, and maintained by the information service for each user. In alternative embodiments, multiple user profiles may be created, stored, and maintained for a given user.

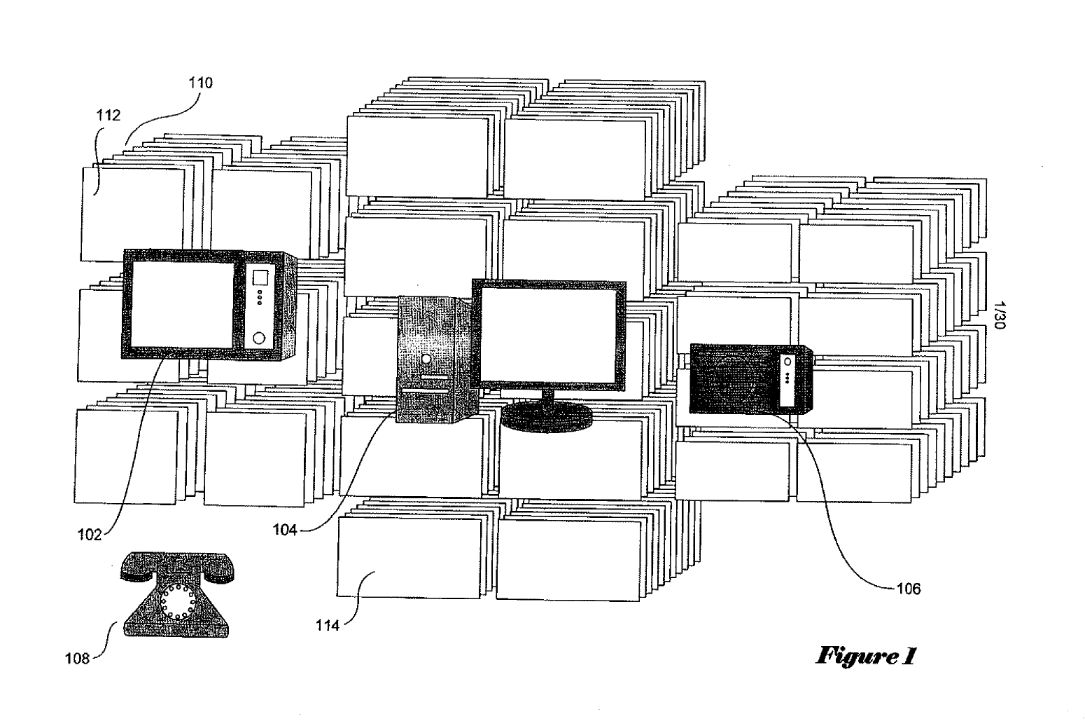

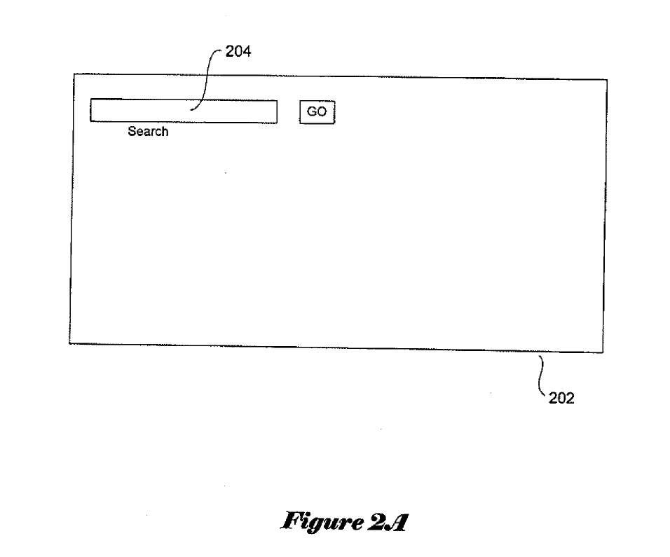

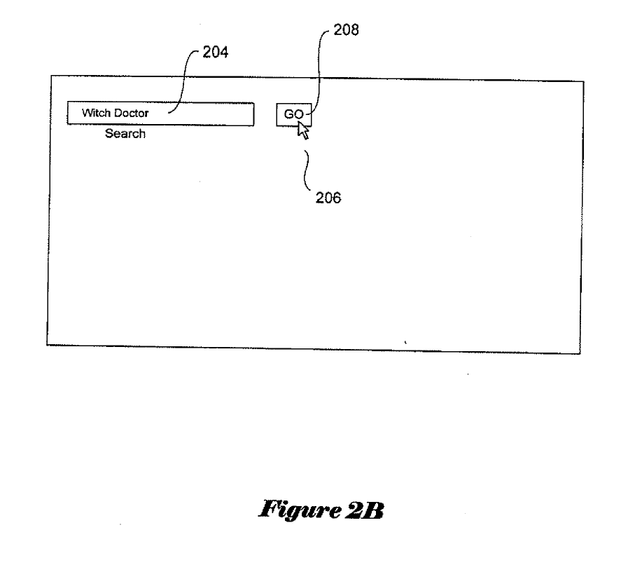

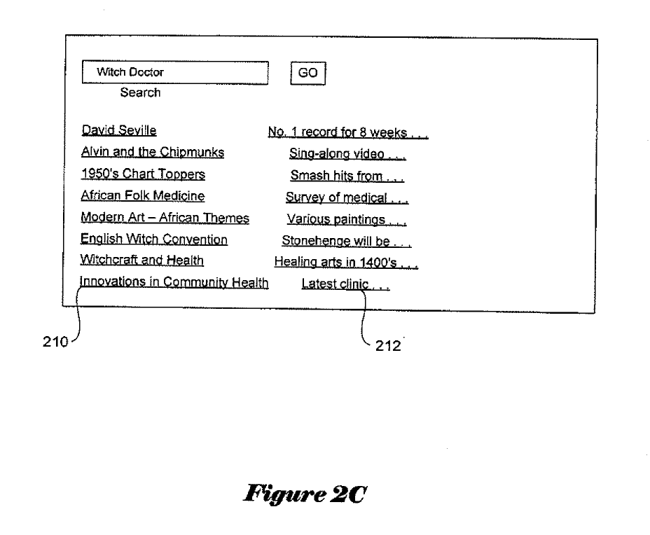

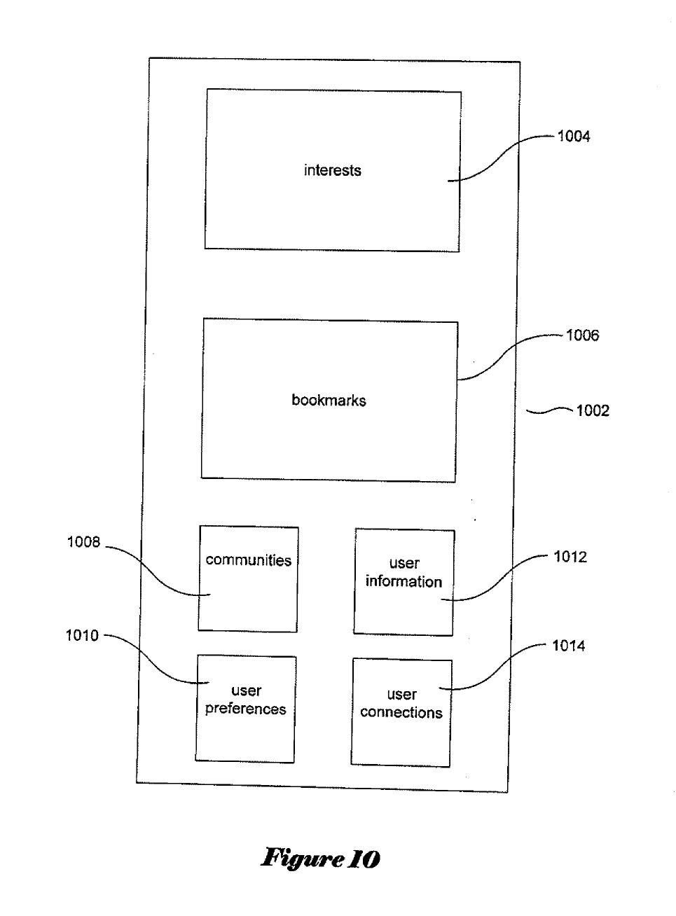

FIG. 11 illustrates a user community of one embodiment of the present invention. As discussed above, and illustrated in FIG. 11, the information service maintains a large number of user profiles 1102, one or more user profiles corresponding to each user, or subscriber, of the information service. The information service also maintains information about one or more user communities 1104. For example, in multiple-community implementations, each entry, such as entry 1106, in the list of user communities includes references 1108 to the user profiles of users that together comprise the community. Alternative implementations, including an implementation discussed below, provide a single community comprising all users of the information service. In multiple-community embodiments, users may specifically join communities using tools provided by the user interface. In addition, in these embodiments, the information service may suggest communities of interest to the user or, in certain embodiments, may automatically associate a user with various communities that the information service determines to be related to interests of the user. In general, as illustrated in FIG. 11, certain portions of a user profile, such as the portions 1110-1112 shown crosshatched in the first user profile 1114 in the set of user profiles 1102 shown in FIG. 11, are allowed to be accessed by other users in the one or more communities to which a user belongs. For example, other users may access all, or a portion of, a user's interests, and bookmarks. Other portions of a user profile, or portions of those other portions, may additionally be allowed, by the information service, to be accessed by other users in the community, including portions of the user's preferences and user information. Certain information within a user's user profile may be shielded from access by other users, either by design, or as specifically requested by the user. By constructing and maintaining one or more communities of users, the information service provides a mean for users to communicate with one another and share interests, preferences, bookmarks, and ratings of various information sources. Thus, referring back to FIG. 1, information services that employ methods and systems of the present invention not only provide a flexible and powerful tool for gathering and viewing information on various information display and rendering devices, but also allow users to communicate with one another through the same interface. Thus, user-interface embodiments of the present invention aggregate capabilities of all of the disparate information gathering, rendering, and display devices commonly employed by home users and professional users of communication systems.

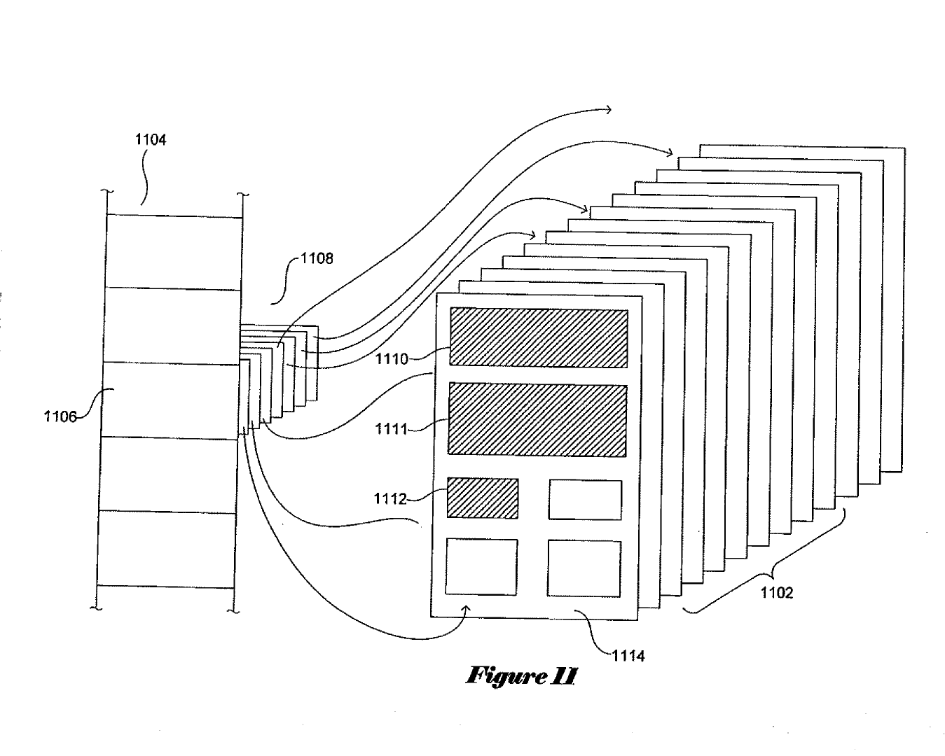

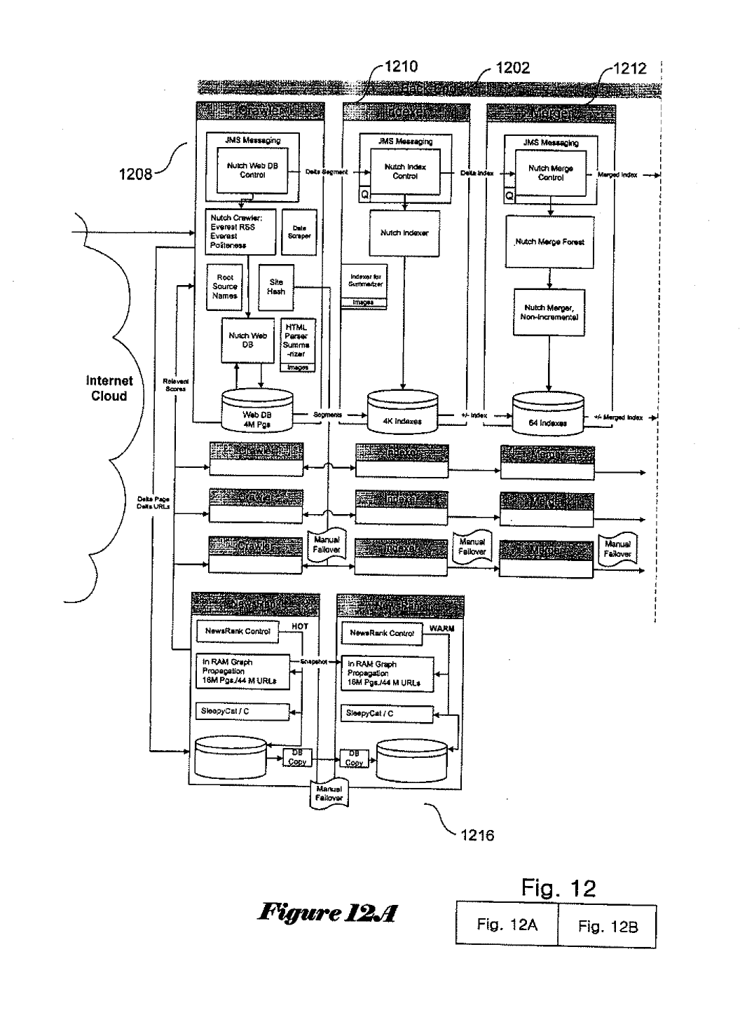

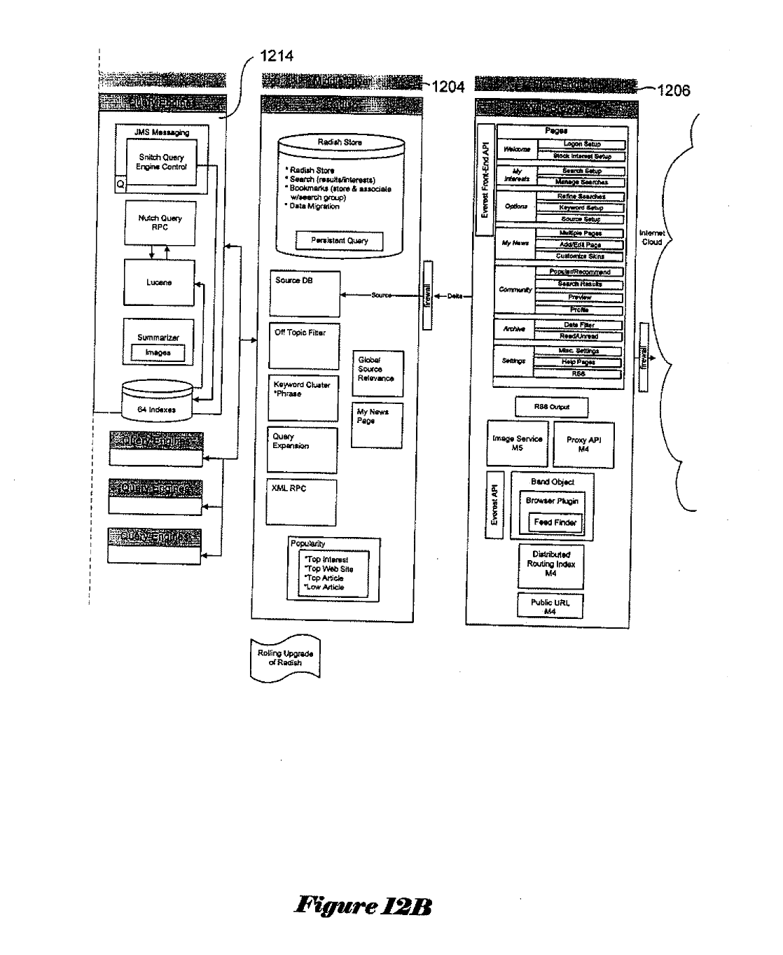

FIGS. 12A-B provides a more detailed architectural diagram of one information-service embodiment of the present invention. This embodiment is directed to compilation of news from various news sources to support a simple, but powerful user interface to allow users to define news interests, manage news interests, receive continuous updates regarding the defined news interests, and communicate with other users within user communities with regard to news interests. The system comprises a complex, back-end information service 1202, a middle layer 1204 responsible for creating and maintaining a view of the compiled information stored by the back end for each user, and a front-end user interface 1206 displayed to each user by the user's web browser, set-top box, television, or other information rendering and display device. The back end 1202 includes a crawler component 1208 that embodies web crawlers, information-accessing-and-processing routines, and other components related to information gathering, an indexer component 1210 for creating, maintaining, and updating indexes for facilitating access to the information compiled and stored by the crawler component 1208, a merge component 1212, a query-engine component 1214 for executing queries associated with interests to return results to users, and a ranking component 1216 that facilitates automated prioritizing and ordering of compiled information based on user input and user preferences. The middle layer 1204 includes components for storing user profiles and for preparing queries corresponding to user's interests for execution by the back end 1202 portion of the information service. The front end 1206 comprises a user interface displayed by a user's browser to the user, as well as a collection of routine calls, web-page-specification files, and other components and information needed to instantiate the user interface by a web browser.

Next, a user interface that represents one user-interface embodiment of the present invention is described, with reference to FIGS. 13-20. FIGS. 13-20 show screen captures of web pages displayed by a web browser displaying a user-interface embodiment of the present invention.

FIG. 13 shows a first screen capture of a web page displayed by a user-interface embodiment of the present invention. The user interface, as shown in FIG. 13, displays a web page accessed by the My Interest tab 1302. Additional web pages accessible through tabs include a My News page associated with the My News tab 1304, a Community page associated with the Community tab 1306, and a My Profile page associated with the My Profile tab 1308. The My Interests page 1310 includes a region with input fields to allow a user to create and add an interest 1312, a region that displays a list of interests maintained by the user 1314, and a results pane 1316 that shows annotated links corresponding to a currently selected interest separated into results for a keyword search, a feed search, and a search for interests within the community. The My Interests web page includes many additional user input devices, features, and displayed information, which are described in the course of describing the interest-adding region 1312, interests list 1314, and results pane 1316.

The interest-adding region 1312 includes a text input field 1318 to allow a user to enter key words, one or more URLs, or a combination of key words and URLs that together comprise a search string to be associated with the interest. An options pane, described below, is accessed by the Options link 1320. All of the interests defined by a user are displayed in the interests list 1314 portion of the My Interests web page. The interests list includes tools for allowing a user to organize interests hierarchically into interest groups. The user may also store individual URLs or links, which can be accessed through the View Saved Links link 1324 at the bottom of the interests-list region. When a user selects, via a mouse click, an interest from within the list of interests, a list of annotated links corresponding to the interest are displayed in the results pane 1316. The square icon associated with each interest, such as square icon 1327, invokes a dialog that allows a user to refine an interest by including, requiring or blocking topics. A pop-up containing a list of topics considered relevant to, or associated with, the interest are displayed, to allow a user to refine the interest by selecting topics associated with the interest that may be used to block or select links from among the results set for the interest for display in the results pane for the interest.

It should be noted that addition of interests by a user not only benefits the individual user who adds the interests, but also serves to enrich the main catalogue maintained by the information service. Added interests therefore may benefit other users of the information, who can access and share interests of others, or who, by searching, end up accessing information originally added to the main catalogue as a result of the interests added by the user.

The results pane 1316 displays a list of search results associated with a selected interest returned by the information service as a result of execution of a search based on the search string associated with a selected interest or interest group. For example, in FIG. 13, the results pane 1316 displays an annotated list of links representing a search result for the interest group “U2 News” 1326 currently selected by the user. The annotated links are separated, in the results pane, by dotted, horizontal lines, such as dotted horizontal line 1328. Each annotated link includes an indication of the interest to which the link is related, such as interest indication 1330 for annotated link 1332, a title 1334, graphic 1336, and summarizing sentences or a summarizing paragraph 1338 that together comprise the summary automatically extracted from the web site or web page by the information service, and a link to the home page, or other primary access point, of the information source 1340. In addition, the annotated link indicates 1342 when the information became available, indicates whether or not the user has accessed the link 1344, provides a means for a user to rate the link 1346-1347, including up-rating and down-rating links, and provides tools for the user to access comments made by other users in one or more of the communities to which the user belongs regarding the information specified by the link 1348. In addition, tools for saving the link 1350 and deleting the link 1352 are also included. The results pane includes additional tools for sorting the results set 1354, for conducting an additional key word search for particular links within the results set 1356, and for hiding links already accessed by the user 1358. The scroll bar 1360 to the right of the result pane can be used by a user to scroll through all of the annotated links within a results set.

Ratings of links and other information sources by a user provide a two-fold benefit. First, the ratings of a user can be employed by the information service to learn, over time, a user's preferences, and to provide information tailored for those preferences. The ratings information can be used by the information service to steer searches made on behalf of the user, and to order displayed information by preference, so that information most likely to be desirable to a user is displayed first. Second, the ratings collected from a user can be used to steer searches, and order displayed results sets, for all other users of communities to which the user belongs, and may, in certain embodiments, be used generally to steer searches, and order displayed results sets, for all other users of the information service. Ratings can be input explicitly, through ratings-entry features, or through monitoring, by the information service, of the click-throughs, access patterns, and other direct user input to the user interface, as well as from other user-input selections, bookmarks, interests and interest categories, and explicit requests to share other users' interests.

The My Interests page, described above, therefore provides an easy to use, highly functional, and manageable window through which the user can gather, organize, access, and maintain information selected using the much larger store of information maintained by an information service, the information stored by the information service itself a relatively small subset of the total amount of information theoretically accessible by a user from information sources such as web pages and television broadcasts. Rather than attempting to monitor hundreds of different broadcast-channel directories and schedules and millions of different web sites and web pages, a user can direct an information service, using tools provided on the My Interests page, to gather and process information of interest to the user and present the processed information to the user through the My Interests page interface. In addition, the user is integrated, through the My Interests page, into an arbitrarily large number of different user communities, in each of which users communicate with one another, sharing interests, comments, and ratings. The information service uses user ratings, bookmarks, and click-throughs as feedback indicating the relevance of web pages, websites, and starting points to the user. This data is used to affect the recall and sorting of pages matching the user's interest criteria, both individually and in the aggregate. That is, the top pages returned to a user for a particular interest are affected strongly by the user's own feedback data and the data of other user's whose feedback is similar to the user. The feedback data of many users may also be aggregated in order to assign an overall relevance score to pages collected by the system. Relevance scores affect recall, in general, and also facilitate prioritization of the collection of pages.

FIG. 14 shows an interest-adding region displayed on the My Interests web page of one embodiment of the present invention when a user undertakes adding an interest to the user's interests list. The interest-adding region 1402 includes a means for adding the interest to an existing interest group 1406.

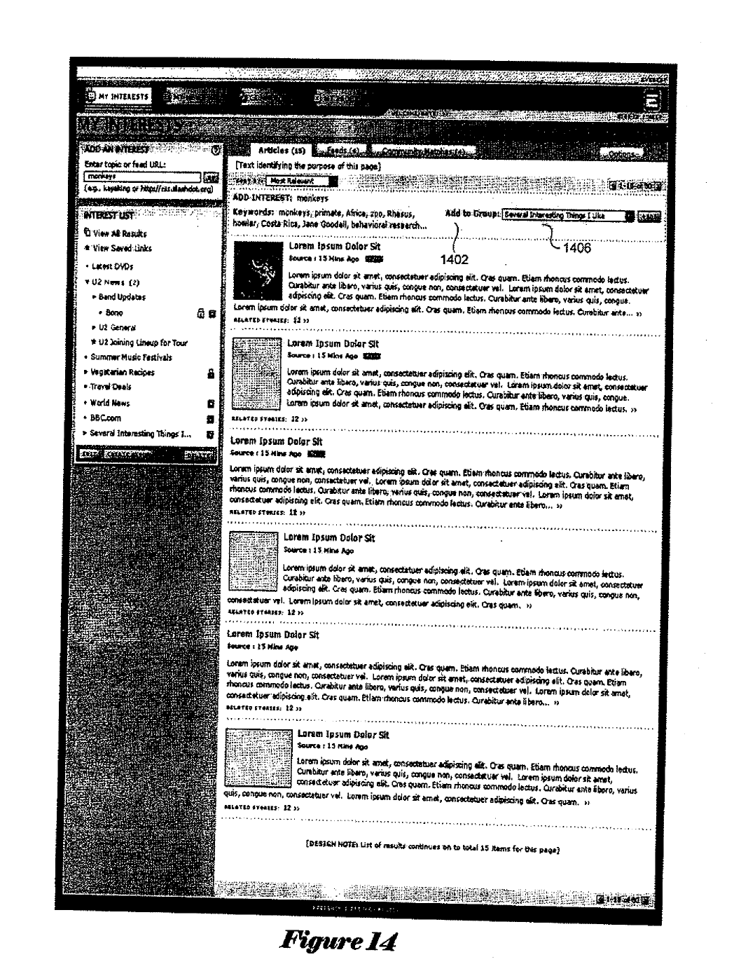

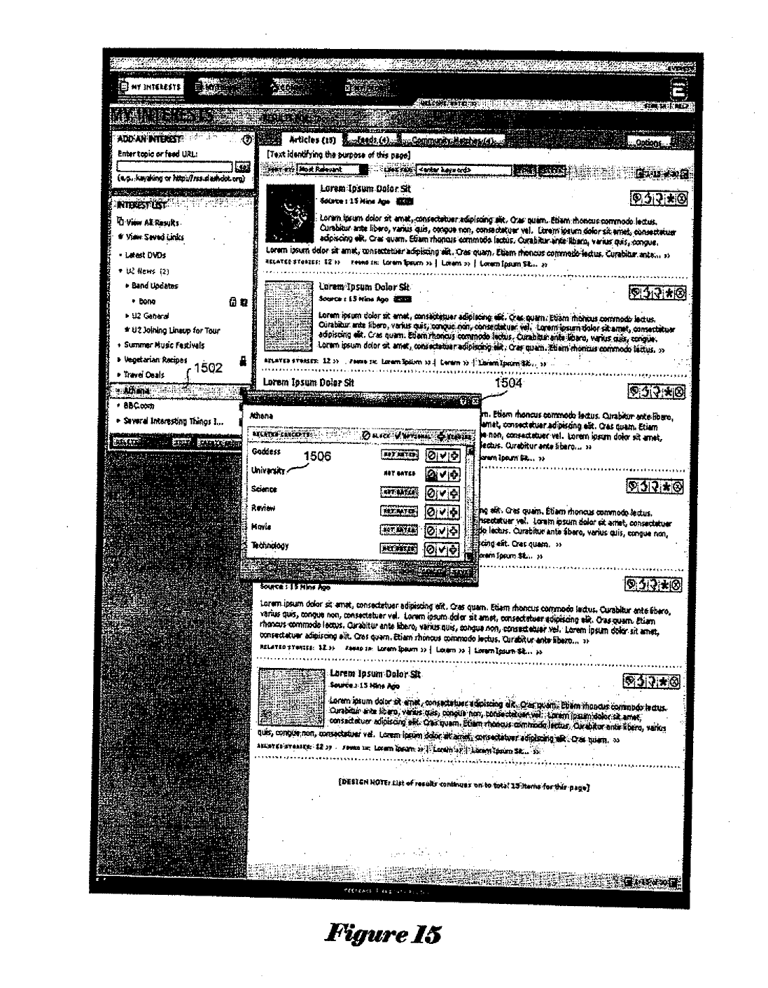

FIG. 15 shows a pop-up menu displayed when a user clicks the square icon associated with an interest in the user's interests list according to one embodiment of the present invention. In FIG. 15, the current interest 1502 has the name “Athena.” By clicking the square icon associated with the interest “Athena” (the square icon is obscured by highlighting in the screen capture shown in FIG. 15), the user invokes the Refine this Interest pop-up 1504 allowing the user to refine the search associated with the interest by blocking, including, or making mandatory, inclusion of links in the results set for the interest that are associated with each of a number of semantic topics. For example, in the example shown in FIG. 15, the user has chosen to block links in the results set for the interest “Athena” related to the topic “University” 1506.

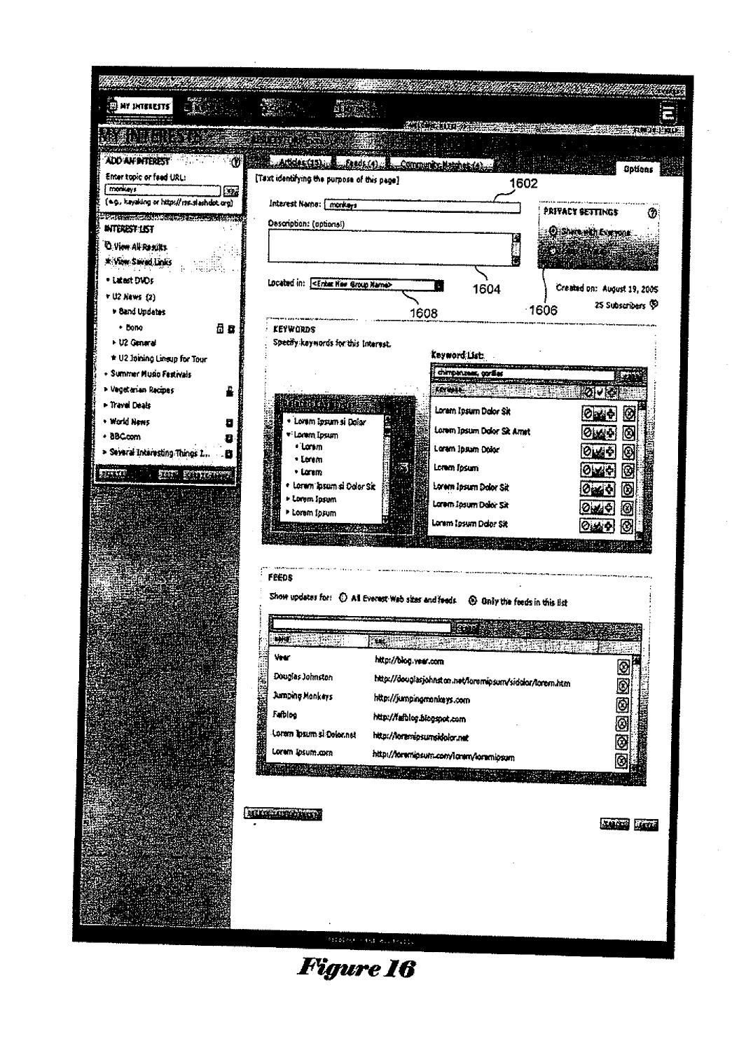

FIG. 16 shows a screen capture of the My Interests web page of one embodiment of the present invention when the options pane is displayed. The options pane allows a user to customize and refine a selected interest so that the results set returned from a search defined by the interest corresponds to information desired by the user. The user can edit the name of the interest 1602, provide an optional description of the interest 1604, indicate whether or not the interest should be sharable with other members of the community 1606, and add the interest to an existing group or type in the name of a new group 1608 for the interest. The options pane provides a user with the ability to add keywords and/or URLs to the search list associated with the interest, edit keywords or URLs within the search list, or delete keywords and/or URLs from the search list, and to require links returned with the results set of the interest to contain particular keywords or URLs, to block links that contain, or are associated with particular key words or URLs, from being returned in the results set for the interest.

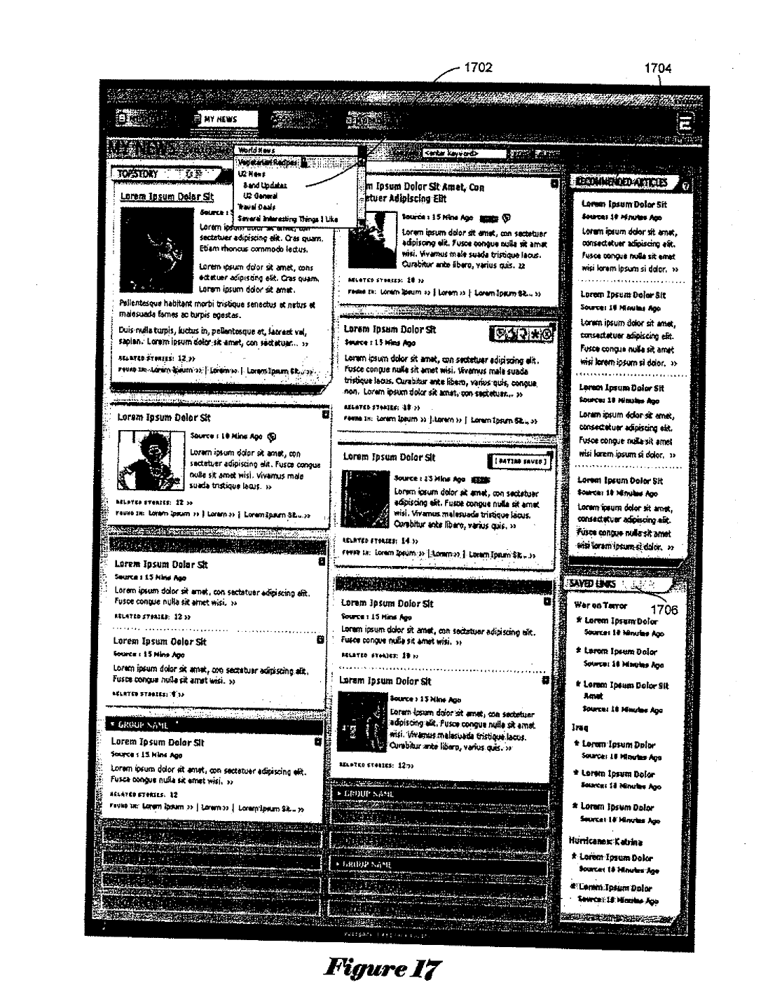

FIG. 17 shows a screen capture in which the My News page of one embodiment of the present invention is displayed. The My News page displays much of the same information displayed by the My Interests page, but uses a different format that emphasizes the annotated links of the results set. The user's list of interests is available from a drop-down menu 1702. Interest creation, editing, sharing, and deleting tools are not included in the My News page. However, the My News page provides a Recommended Community Interests section 1704 in which the information service displays interests from other users of the various communities that the information service has determined to be of potential interest to the user. A user may also access any saved links through the Saved Links link 1706 included in the My News page.

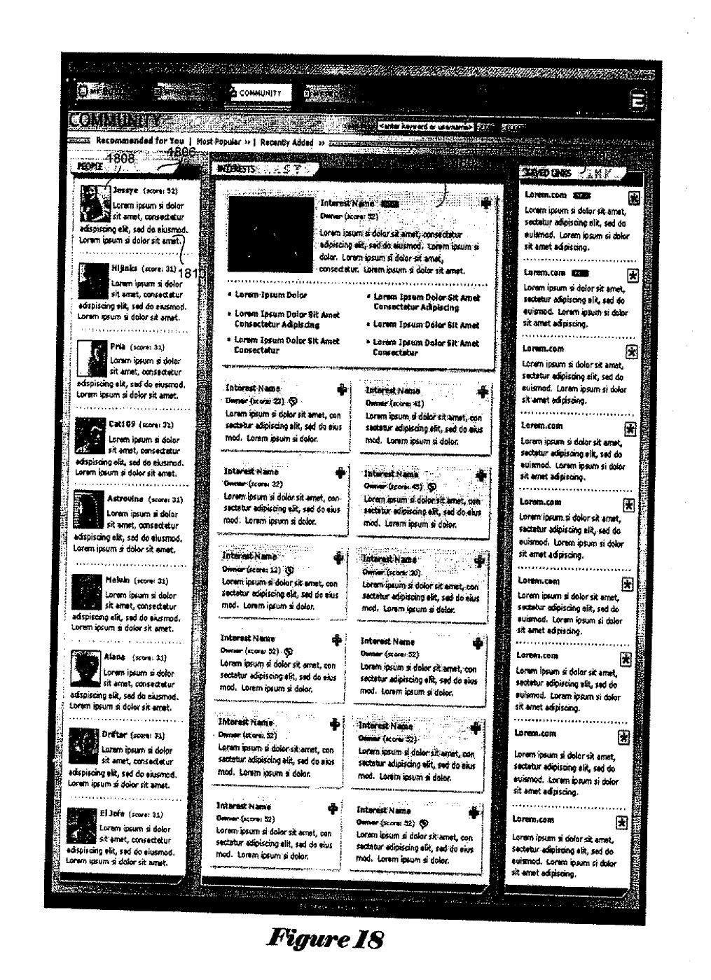

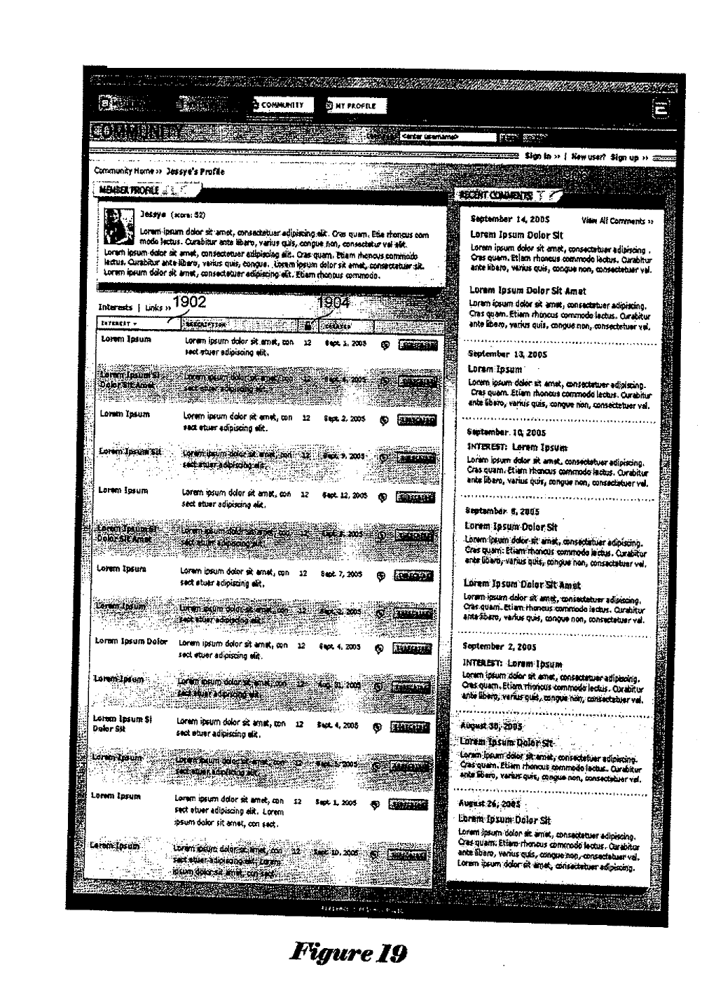

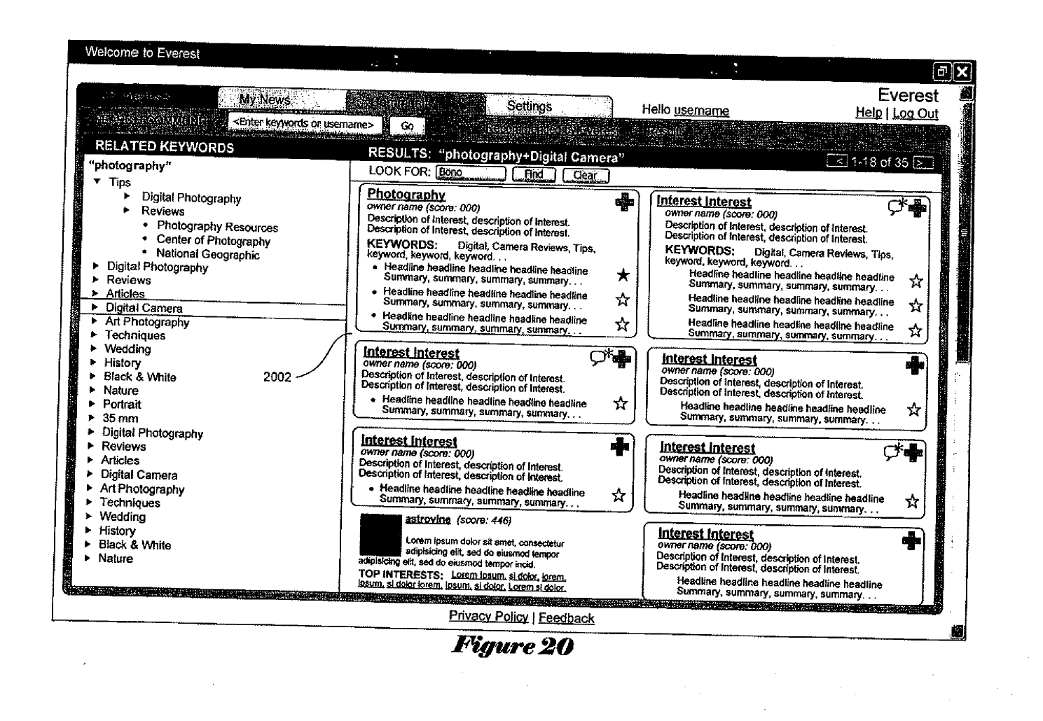

FIG. 18 shows a screen capture of a displayed Community page of one embodiment of the present invention. The Community page allows a user to view interests created by other users in the community, to view other users' saved articles and URLs, to view portions of other users' user profiles, to view comments forums, and to otherwise participate in various communities of users. The Community page displays a set of interests 1802 the information service determines to be of potential interest to the user, allowing the user to subscribe to any of the displayed interests or, in other words, to include the displayed interest or interests of other users in the user's own user profile. The Community page also displays saved links 1804 and other users within the community 1806 who the information service has determined to have similar interests with a user. When displaying other users, the Community page shows a picture of each user, such as the picture 1808 displayed for the user along with a description of the user 1810. Users can then view the user's Member Profile as shown in FIG. 19. User's can view an ordered list of interests 1902 created by the user, and the number of other users that have subscribed to each of the user's interests 1904 and also their latest comments 1906. From the Community page, FIG. 18, a user may also search a community for user interests that include particular key words or URLs, using a search tool 1812 provided at the top of the Community page. FIG. 20 shows a results set of interests that contains key words or URLs specified by the user through the search tools provided on the Community page of one embodiment of the present invention. Each displayed interest in the results set, such as interest 2002, includes an interest title, indication of the owner of the interest, a description of the interest, and key words associated with the interest.

Although the present invention has been described in terms of particular embodiments, it is not intended that the invention be limited to these embodiments. Modifications within the spirit of the invention will be apparent to those skilled in the art. For example, an almost limitless number of different implementations of the information service can be created, using different hardware and software platforms, different programming languages, different modular organizations, control structures, data structures, and other such characteristics and parameters of system design. Similarly, the user interface provided by the information service to users or subscribers can be implemented using many different user-interface-creation tools, programming languages, underlying data structures, and other such characteristics and parameters. Providing a highly functionable, but usable user interface requires balancing many different constraints and goals, subsets of which may not be compatible with one another. Although the disclosed user-interface embodiment provides sufficient functionality for a user to gather, access, maintain, and organize information from many different information sources, it is conceivable that additional tools, features, and facilities may be added to the user interface to further facilitate the user's information-related goals. However, when user interfaces become overly complex and feature rich, they often become less usable and desirable from a user's standpoint. Therefore, although additional features and facilities may be added to the disclosed user interface, user interfaces representing embodiments of the present invention all share an overall simplicity and economy in feature sets, to avoid undue complexity and deterioration in usefulness or appear to users. Although the disclosed user interface partitions functionality, displayed information, tools, facilities, and features among four main, tabbed pages and additional menus, pop-ups, and subpages displayed within each of the four main pages, many other, alternative organizations are possible. Furthermore, different organizational techniques may be used. For example, many of a plethora of page-selection devices may be used instead of, or in addition to, tabs for other techniques employed in the disclosed user-interface embodiment. Furthermore, the positions, groupings, ethical representations, and other characteristics of features, facilities, and displayed information will be substantially altered in alternative embodiments.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1-41. (canceled)

42. A method for gathering, compiling, and distributing information from multiple information sources to users of an information service, implemented on multiple electronic computer systems, the method comprising:
continuously monitoring, by one or more of the multiple electronic computer systems, the information sources to extract information from the information sources and compile the extracted information in a catalog maintained on an information-service computing and data storage system, the catalog including stored information and multiple indexes that each associates references to the stored information with an attribute and that together facilitate searching of the stored information for particular items of stored information;
receiving, by one or more of the multiple electronic computer systems, user information interests and user data from users and storing the received user information interests and user data within the information-service computing and data storage system; and
for each active user, continuously searching, by one or more of the multiple electronic computer systems, the catalog for information related to the user's interests, extracting the information related to user's interests, and providing the extracted information to the user through a user interface instantiated on any one or more of various types of information-rendering-and-display devices, including a personal computer and a set-top-box equipped television.

43. The method of claim 42 the attribute associated with a reference to the stored information within an index is selected from among:
a key word that occurs in the item of stored information referenced by the reference;
a phrase that occurs in the item of stored information referenced by the reference;
a universal resource locator that is used to locate the item of stored information referenced by the reference in the web;
a character string or number derived from information included in the item of stored information referenced by the reference; and
a character string or number derived from the item of stored information referenced by the reference

44. The method of claim 42
wherein the multiple information sources include electronic program guide information; and
wherein the information service provides electronic program guide information to a user's digital video recorder to schedule recording of broadcast programs of interest to the user.

45. The method of claim 42
wherein the multiple information sources include web sites and web pages accessible from web servers through the Internet.

46. The method of claim 45 wherein continuously monitoring the information sources further comprises:
executing one or more information-and-accessing-and-processing routines that access web sites and web pages according to information-retrieval tasks dequeued from one or more information-retrieval-task queues; and
executing one or more web crawler routines that queue information-retrieval tasks to the one or more information-retrieval-task queues, the information-retrieval tasks queued by the one or more web crawler routines so that a particular web server is accessed less than a predefined access-threshold number of times within a specified time period.

47. The method of claim 45 wherein the one or more web crawler routines queue information-retrieval tasks to maximize the amount of information processed, within a given time period, by the one or more information-and-accessing-and-processing routines.

48. The method of claim 45 wherein a web crawler carries out a limited search from a specified information-source starting point by receiving a distance/radius allocation pair, and decrementing the received radius allocation when traversing an inter-website link and decrementing the received distance allocation when traversing an intra-website link.

49. The method of claim 45 wherein the information-and-accessing-and-processing routines continuously determine user interests relevant to accessed information sources, and cache the relevant user interests and accessed information for subsequent update of user interests.

50. The method of claim 45 wherein the one or more information-and-accessing-and-processing routines access web servers and process web-page specifications returned by the web servers to extract suitable titles, graphics, and summary text with which to annotate links displayed to users corresponding to the returned web-page specifications.

51. The method of claim 50 wherein the information-and-accessing-and-processing routines extract suitable titles, graphics, and summary text with which to annotate links displayed to users corresponding to the returned web-page specifications by:
analyzing the web-page specifications to recognize non-semantic specification characteristics and features, including patterns of commands and/or tags, statistical characteristics of words within text, and position of information within the specification, to recognize non-semantic fingerprints indicative of titles, graphics, and summary text suitable for annotating displayed links; and
extracting titles, graphics, and summary text from portions of the web-page specifications associated with the recognized non-semantic fingerprints.

52. The method of claim 50 wherein the information-and-accessing-and-processing routines extract suitable titles, graphics, and summary text with which to annotate links displayed to users corresponding to the returned web-page specifications by:
when a title is included in metadata associated with the web-page,
locating and extracting a title from the web-page similar to the title included in metadata associated with the web-page, and
extracting text proximal to the extracted title for a summary annotation and extracting an image proximal to the extracted title for an image annotation; and
when no title is included in metadata associated with the web-page,
parsing elements from the webpage,
vectorizing the parsed elements into metrics vectors,
resolving the metrics vectors into result vectors that include a classification and a confidence level, and
choosing as title, summary, and image annotations the elements classified by the resolver as a title, summary, and image with greatest confidence levels.

53. The method of claim 45 wherein user data includes bookmarked web-site and webpage links, and wherein information interests and user data are maintained in the information-service computing and data storage system to allow a user to access the user's information interests and data, including bookmarked web-site and webpage links and/or an archived snapshot of a web page, from any of the one or more of various types of information-rendering-and-display devices.

54. The method of claim 45 wherein, in addition to user interests and user data, including bookmarked web-site and webpage links, indications of user membership in communities is stored in the information-service computing and data storage system to allow a user of a community to access and share portions of the user information of other users of the community.

54. The method of claim 45 wherein a user interest comprises an interest name and a search list used by the information service to search for information related to keywords and information-source specifiers contained in the search list.

56. The method of claim 45 wherein continuously searching the catalog for information related to the user's interests further includes searching other information sources indicated by the user and indicated by automated processes for finding information related to a user's interest.

57. The method of claim 45 wherein information sources include schedules and programs for broadcast of programs and music through broadcast media, including television and radio.

58. An information service, implemented on multiple electronic computer systems, that gathers, compiles, and distributes information from multiple information sources to users of the information service, the information system comprising:
a back end component of the information system, comprising one or more computer systems, that continuously monitors the information sources to extract information from the information sources and compile the extracted information in a catalog maintained on an information-service computing and data storage system, the catalog including stored information and multiple indexes that each associates references to the stored information with an attribute and that together facilitate searching of the stored information for particular items of stored information; and
a middle layer component of the information system, comprising one or more computer systems, that
receive user information interests and user data from users and stores the received user information interests and user data within the information-service computing and data storage system, and that
continuously invokes back-end searching facilities for searching the catalog for information related to the user's interests, extracting the information related to user's interests, and providing the extracted information to the user through a user interface instantiated on any one or more of various types of information-rendering-and-display devices, including a personal computer and a set-top-box equipped television.

59. The method of claim 58 the attribute associated with a reference to the stored information within an index is selected from among:
a key word that occurs in the item of stored information referenced by the reference;
a phrase that occurs in the item of stored information referenced by the reference;
a universal resource locator that is used to locate the item of stored information referenced by the reference in the web;
a character string or number derived from information included in the item of stored information referenced by the reference; and
a character string or number derived from the item of stored information referenced by the reference

60. The information service of claim 58
wherein the multiple information sources include electronic program guide information; and
wherein the information service provides electronic program guide information to a user's digital video recorder to schedule recording of broadcast programs of interest to the user.

61. The information service of claim 58
wherein the multiple information sources include web sites and web pages accessible from web servers through the Internet.

62. The information service of claim 61 wherein the back end continuously monitors the information sources to extract information from the information sources and compiles the extracted information in a catalog maintained on an information-service computing and data storage system by:
executing one or more information-and-accessing-and-processing routines that access web sites and web pages according to information-retrieval tasks dequeued from one or more information-retrieval-task queues; and
executing one or more web crawler routines that queue information-retrieval tasks to the one or more information-retrieval-task queues, the information-retrieval tasks queued by the one or more web crawler routines so that a particular web server is accessed less than a predefined access-threshold number of times within a specified time period.

63. The information service of claim 62 wherein the one or more web crawler routines queue information-retrieval tasks to maximize the amount of information processed, within a given time period, by the one or more information-and-accessing-and-processing routines.

64. The information service of claim 62 wherein a web crawler may carry out a limited search from a specified information-source starting point by receiving a distance/radius allocation pair, and decrementing the received radius allocation when traversing an inter-website link and decrementing the received distance allocation when traversing an intra-website link.

65. The information service of claim 62 wherein the information-and-accessing-and-processing routines continuously determine user interests relevant to accessed information sources, and cache the relevant user interests and accessed information for subsequent update of user interests.

66. The information service of claim 62 wherein the one or more information-and-accessing-and-processing routines access web servers and process web-page specifications returned by the web servers to extract suitable titles, graphics, and summary text with which to annotate links displayed to users corresponding to the returned web-page specifications.

67. The information service of claim 62 wherein the information-and-accessing-and-processing routines extract suitable titles, graphics, and summary text with which to annotate links displayed to users corresponding to the returned web-page specifications by:
analyzing the web-page specifications to recognize non-semantic specification characteristics and features, including patterns of commands and/or tags, statistical characteristics of words within text, and position of information within the specification, to recognize non-semantic fingerprints indicative of titles, graphics, and summary text suitable for annotating displayed links; and
extracting titles, graphics, and summary text from portions of the web-page specifications associated with the recognized non-semantic fingerprints.

68. The information service of claim 62 wherein the information-and-accessing-and-processing routines extract suitable titles, graphics, and summary text with which to annotate links displayed to users corresponding to the returned web-page specifications by:
when a title is included in metadata associated with the web-page,
locating and extracting a title from the web-page similar to the title included in metadata associated with the web-page, and
extracting text proximal to the extracted title for a summary annotation and extracting an image proximal to the extracted title for an image annotation; and
when no title is included in metadata associated with the web-page,
parsing elements from the webpage,
vectorizing the parsed elements into metrics vectors,
resolving the metrics vectors into result vectors that include a classification and a confidence level, and
choosing as title, summary, and image annotations the elements classified by the resolver as a title, summary, and image with greatest confidence levels.

69. The information service of claim 61 wherein user data includes bookmarked web-site and webpage links, and wherein information interests and user data are maintained in the information-service computing and data storage system to allow a user to access the user's information interests and data, including bookmarked web-site and webpage links and/or an archived snapshot of a web page, from any of the one or more of various types of information-rendering-and-display devices.

70. The information service of claim 61 wherein, in addition to user interests and user data, including bookmarked web-site and webpage links, indications of user membership in communities is stored in the information-service computing and data storage system to allow a user of a community to access and share portions of the user information of other users of the community.

71. The information service of claim 61 wherein a user interest comprises an interest name and a search list used by the information service to search for information related to keywords and information-source specifiers contained in the search list.

72. The information service of claim 61 wherein continuously searching the catalog for information related to the user's interests further includes searching other information sources indicated by the user and indicated by automated processes for finding information related to a user's interest.

73. The information service of claim 61 wherein information sources include schedules and programs for broadcast of programs and music through broadcast media, including television and radio.
